(19) United States
(12) Patent Application Publication
(10) Pub. No.: US 2014/0358655 A1
(43) Pub. Date: Dec. 4, 2014

(54) METHOD AND SYSTEM FOR CREDIT PARTY REDEMPTION

(71) Applicant: XENLULU LLC, Hingham, MA (US)

(72) Inventor: Joseph Anthony Wheeler, Hingham, MA (US)

(73) Assignee: XENLULU LLC, Hingham, MA (US)

(21) Appl. No.: 14/069,573

(22) Filed: Nov. 1, 2013

Related U.S. Application Data
(60) Provisional application No. 61/897,254, filed on Oct. 30, 2013.
(60) Provisional application No. 61/870,589, filed on Aug. 27, 2013.
(60) Provisional application No. 61/828,893, filed on May 30, 2013.

(51) Int. Cl. G06Q 30/02

(52) U.S. Cl. CPC G06Q 30/0226; G06Q 30/0214
USPC 705/14.16; 705/14.33

(57) ABSTRACT

The invention provides systems and methods for administering a rewards program in which points are earned by both shopping and online promotional activity. The rewards program preferably includes real-time earning of points and real-time price reductions. In certain aspects, the invention provides a method of influencing consumer behavior that includes using a computer system for giving consumers reward points for performing activities that include both online shopping and online brand promotion, offering the consumers a discount on a purchase, and—for each consumer that accepts the offer—depleting that consumer's reward points by an amount.

### CROSS-REFERENCE TO RELATED APPLICATIONS

This application claims priority to, and the benefit of, U.S. Provisional Patent Application Ser. No. 61/828,893, filed May 30, 2013; U.S. Provisional Patent Application Ser. No. 61/870,589, filed Aug. 27, 2013; and to U.S. Provisional Patent Application Ser. No. 61/897,254, filed Oct. 30, 2013, the contents of each of which are incorporated by reference for all purposes.

### FIELD OF THE INVENTION

The invention generally relates to rewards programs that offer incentives for both purchase activity and promotion activity by a consumer.

### BACKGROUND

Despite the fact that many credit card issuers have tried to engage customers in loyalty programs, research firms have reported that “loyalty programs today fail to drive loyalty—transaction or otherwise—and need to reimagine their approach.” Such reports give five major reasons that loyalty programs fail: loyalty programs operate in a silo, loyalty programs target too many people, loyalty programs fail to engage members beyond the transaction, the perceived value of the reward is lower than the actual value, and loyalty programs fail to stand out in the marketplace. These criticisms are borne out by data indicating that not many consumers feel that loyalty programs save them money or offer instant discounts and savings. Additionally, a loyalty program that is specialized to serve one customer may be particularly unsatisfactory to another.

### SUMMARY

The invention provides a real-time rewards platform that engages consumers with credit card issuers by allowing the issuer to give rewards points for both purchase activity and promotional activity. The invention is a mobile rewards platform that solves problems with loyalty programs. Systems and methods of the invention allow merchants and issuers to apply personalized, precise discounting that protects retail gross margins while significantly increasing average ticket. Additionally, the invention provides a unique a way to achieve consistent discounts for consumers. For issuers and rewards marketers, the invention provides a data-based way to forecast—and even shape—demand based on consumer responses to earn and redeem reward points.

The implications are significant. As the retailer or issuer grows their percentage of customers participating in the mobile-based rewards program, their precision around pricing and discounting achieves the maximum value that can be earned from a particular product for a particular customer.

One key concept behind the invention is to reward customers that demonstrate a high level of customer loyalty and advocacy with consistent discounts that recognizes their value. A distinguishing feature of the invention is that the way those discounts are personalized to the consumer, not in the actual price discount itself but in the number of reward points required to achieve the discount. Customer “A”, who demonstrates little social advocacy and little if any past purchase loyalty will require significantly more reward points to achieve the same discount as Customer “B” who regularly uses social tools to promote the company, shops there frequently, and buys two or more items when they do. The way the invention determines how many reward points are required to achieve a specific discount is based on a real time calculation of several factors which include the past social and shopping behaviors of the customer and the retailer's desire to sell the specific product.

As a result, retailers experience a more consistent flow of sales over a lower marketing cost and customers that demonstrate strong loyalty are rewarded appropriately at a discount level that provides them with significant savings, but without significantly impacting the retailers' operating margins.

In certain aspects, the invention provides a method of influencing consumer behavior comprising using a computer system for giving a consumer reward points for performing activities that include online promotional activity (e.g., use of a social network web site) and the purchasing of a product, receiving a transaction request from a payment institution, debiting a merchant account by a discount amount, crediting the payment institution, and depleting the consumer's reward points by an amount. In a preferred embodiment, the payment institution comprises a credit card issuer. Preferably, the method includes depleting reward points for different people at different redemption rates. Different redemption rates may be determined for each consumer by calculating a value for a function that includes variables such as an amount of points earned, a frequency at which points have been earned, an amount of social network activity in a period of time, a time since a last transaction, a time of day, and a company defined discriminant factor.

In some embodiments, the method includes providing the consumer with a computer executable application that a consumer can execute on a mobile computing device to cause the mobile device to scan a product code and display on the mobile device a discounted price for product. The mobile device may identify itself to a system of the invention by phone number, MAC address, IP address, other unique identifier, or a combination thereof. Preferably, displaying the discounted price is done by displaying an original price number, displaying a transition, and displaying a final discounted price number (e.g., a rollback animation). The method may involve giving consumers reward points for performing activities that include performing assigned missions.

Aspects of the invention provide a device for facilitating a purchase that has a mobile device form-factor body and includes a processor coupled to a non-transitory memory and operable to cause the apparatus to: obtain an identity of a product, receive a transaction request initiated by a payment institution (e.g., an issuer), display an undiscounted price for the product and a discounted price for the product, and show a user a rewards point balance depleted. The apparatus may debit a rewards point account of the user an amount of rewards points. In some embodiments, the consumer may use the apparatus to scan a surface (e.g., a barcode, title, QR code, or picture) to obtain the identity of the product.

In related aspects, the invention provides a method of influencing consumer behavior by using a computer device comprising a non-transitory memory coupled to a processor to: give consumers reward points for performing activities that include online activity such as the use of a social networking web site and the purchasing of a product, process a transaction request from a credit card issuer, offer the consumers a discount on a purchase, and for each consumer that accepts the offer, deplete that consumer's reward points by an amount, debit a merchant account by an amount of the discount, and pay the issuer. The method preferably includes depleting each consumer's reward points at a personalized redemption rate. Each consumer may be given a mobile app for use on a mobile device to implement steps of the method.

Aspects of the invention provide a system for providing products, the system comprising a computer system operable to tally an amount of points earned by each of a plurality of people through a combination of promotional and shopping activity in a computer system, offer a discount to each of the plurality of people at a personalized point rate, debit a merchant at least a first portion of the discount, and credit an issuer at least a second portion of the discount. By including an issuer, the invention provides a valuable loyalty program for a credit card firm. The issuer may fund the discount by accepting the credit and invoicing each of the plurality of people by the discounted amount. In certain embodiments, offering the discount includes causing a mobile device to display the discounted price. The computer system may be operable to cause a computer device to display an animation showing the retail price change to the discounted price. Optionally, the computer system is operable to assign missions to each of the plurality of people, and points are earned by performing the assigned missions. Missions may include promoting a product to users of a web site.

In certain aspects, the invention provides a method of influencing consumer behavior comprising using a computer system for giving consumers reward points for performing activities that include promotional activity and the purchasing of a product. The method includes offering the consumers a discount on a purchase and, for each consumer that accepts the offer, depleting that consumer's reward points by an amount, wherein at least one step is performed by a credit card firm such as an issuer or network. Further, the method can include giving consumers reward points for performing activities that include performing assigned missions. This can include verifying completion of the assigned missions by receiving an image from a consumer. The assigned missions may include recommending a product through the use of a web site. The missions may be assigned at a frequency that is influenced by a speed of completion of previously-assigned missions. Offering the consumers a discount on a purchase may be done by providing the consumer with a computer executable application that a consumer can execute on a mobile computing device to cause the mobile device to scan a product code and displaying on the mobile device a discounted price for product. In a preferred embodiment, displaying the discounted price comprises displaying an original price number, displaying a transition; and displaying a final discounted price number (i.e., a rollback animation).

In some embodiments, each consumer's reward points are depleted at a personalized redemption rate. Determining a redemption rate for each consumer comprises calculating a value for a function in which variables may include any combination of an amount of points earned; a frequency at which points have been earned; an amount of social network activity in a period of time; a time since a last transaction; a time of day; and a company defined discriminant factor.

Aspects of the invention provide an apparatus for facilitating a purchase that includes a mobile device form-factor body, a scanning device borne by the body, and a processor coupled to a memory and the scanning device and housed by the body. The apparatus is operable to scan a product code to determine an identity of a product, determine that a user of the apparatus is a participant in a reward program that grants reward points for performing activities that include the use of a social network website and the purchasing of a product, display a predetermined discount to the user, debit a rewards point account of the user an amount of rewards points, and communicate with an issuer.

In certain aspects, the invention provides a system for influencing consumer behavior administered by a credit card firm such as an issuer, the system comprising a computer device comprising a memory coupled to a processor operable to cause the system to give consumers reward points for performing activities that include the use of a social network website and the purchasing of a product, offer the consumers a discount on a purchase; and—for each consumer that accepts the offer—deplete that consumer's reward points by an amount.

Aspects of the invention provide a system through which a credit card firm may provide rewards to a user. The system includes one or more computers operable to store a user profile in a tangible, non-transitory memory, the profile comprising a user history and a stored value of reward points earned by a combination of shopping and promotional activity. The system can receive information from a user identifying a product that is available for purchase at a price and offer the product to the user for a discounted price on the condition that the stored value of reward points decreases by a redemption cost.

In some aspects, the invention provides a system for providing products, the system comprising a computer system operable to tally an amount of points earned by each of a plurality of people through a combination of promotional and shopping activity in a computer system, offer an incentive to each of the plurality of people, and provide incentives to each of the people in exchange for points. Preferably, providing the incentive comprises debiting a discounted price to a merchant and sending a credit to an issuer, as well as causing a mobile device to display the discounted price. In some embodiments, the computer system is operable to assign missions to each of the plurality of people, and further wherein the points are earned by performing the assigned missions. Missions may include purchasing a product and providing to the computer system verification that the product was purchased. Preferably, missions include promoting a product to users of a web site.

Aspects of the invention provide systems and methods for administering a rewards program in which some certain discount can be offered to all participants, and in which any given participant obtains that discount by redeeming points earned through the use of a credit card at a personalized redemption rate. Points can be earned by activities that can include shopping, social media activity, or both. The personalized redemption rate is determined according to factors such as the history of activity of a user. For example, a user with frequent purchases or frequent promotions of a brand on a social media web site can be offered a discount on a purchase for a certain number of points. Another user with infrequent purchases or infrequent visits to the social media website can be offered the same discount for a different number of points (e.g., fewer) to incentivize that user to get more involved in the program. Alternatively, a merchant can give a highly involved user a more favorable redemption rate (e.g., points/discount value), thus gearing the whole program to incentivize participants to make more purchases and promote brands via social media more frequently.

The rewards program preferably includes real-time earning of points and real-time price reductions. Since consumers can see their points accrue as they perform shopping and social media activities, and since they also see prices drop right in front of their eyes at the time of purchase based on their participation in the program, the real-time nature of the program is communicated and the consumer comes to understand the benefits to be had from staying involved in the dynamic, evolving program. The consumer has an incentive to communicate to others about products via social media, or about the rewards program itself, giving more people the opportunity to experience the benefits of the products and program. Earning points can be based on activities (purchasing, liking a brand) and merchants can create specific structured activities styled as missions that consumers complete to earn points. The mission structure provides a tool by which a merchant can accomplish one goal, such as promoting a new brand by specific media such as photos on a social networking site, while consumers are engaged in an interesting game-like activity that is rewarding in its own right.

Since the rewards program can include a personalized redemption rate, consumers can be given personalized discounts based on variables relating to their purchase history, social media activity, participation in the program, or other things a merchant or administrator is interested in including. Since rewards can be given to the consumers as discounts in which all consumers receive the same discount on any given purchase, the program avoids giving different prices to different people and thus builds trust while discouraging arbitrage. These features of personalized redemption rate and consistent discounts make for a rewards program that yields high consumer welfare and delivers desired products to people at prices that they wish to pay.

In certain aspects, the invention provides a method of influencing consumer behavior that includes using a computer system for giving consumers reward points for performing activities, determining a redemption rate for each consumer, offering the consumers a discount on a purchase, and—for each consumer that accepts the offer—depleting that consumer's reward points by an amount inversely proportional to that consumer's redemption rate while debiting and crediting a merchant and a credit card firm respectively.

The consumers may be given reward points for performing activities that include the use of a social network website and the purchasing of a product.

Offering the consumers a discount on a purchase can be done by providing the consumer with a computer executable application (e.g., a mobile app) that the consumer can execute on a mobile computing device to cause the mobile device to scan a product code and displaying on the mobile device a discounted price for product. The discounted price can be shown as a “rollback”, e.g., by displaying an original price number, displaying a transition, and displaying a final discounted price number (the transition can be an animation of numbers between the original price number and the final discounted price number).

Methods of the invention can also include mission-based embodiments, in which the method includes assigning missions to a consumer or giving consumers reward points for performing activities that include performing assigned missions. Completion of the assigned missions can be verified by receiving an image from a consumer.

Assigned missions can include recommending a product through the use of a web site, uploading a picture of a product, recruiting another person to join the rewards program, others, or a combination thereof. Missions themselves may be influenced according to a differential algorithm. For example, missions can be assigned at a frequency that is influenced by a speed of completion of previously-assigned missions. Missions can be personalized to a consumer based on information known about that consumer.

Preferred embodiments include personalized reward redemption rates. In some embodiments, the determining a redemption rate for each consumer is done by calculating a value for a function in which variables could include any of an amount of points earned, a frequency at which points have been earned, an amount of social network activity in a period of time, a time since a last transaction, and a time of day. The calculation may also make reference to a discriminant factor, such as a status in a rewards program.

In other aspects, the invention provides method of providing rewards to a user by storing a user profile in tangible, non-transitory memory of a computing device. The profile includes a user history and a stored value of reward points. The method further includes analyzing with a processor coupled to the memory the user history with a scoring algorithm to provide a score that is indicative of the relative value for the user profile. Information is received from a user identifying a product that is available for purchase at a price. The method includes offering the product to the user for a discounted price—the discount to be borne by a credit card firm until credited by an admin—on the condition that the stored value of reward points decreases by a redemption cost inversely proportional to the relative value.

In related aspects, the invention provides method of providing rewards to a user by storing a user profile in tangible, non-transitory memory of a computing device. The profile includes a user history and a stored value of reward points. The method further includes analyzing with a processor coupled to the memory the user history with a scoring algorithm to provide a redemption value, calculated using input from a credit card firm such as an issuer. Information is received from a user identifying a product that is available for purchase at a price. The method includes offering the product to the user for a discounted price on the condition that the stored value of reward points decreases by a redemption cost that is based on the redemption value.

In certain aspects, the invention provides process for providing products to people. The process includes tallying an amount of points earned by each of a plurality of people in a computer system and offering an incentive (such as a discount from a retail price) to each of the plurality of people. The incentive is provided to a first person and to a second person, subject to those people paying with a credit card. The first person's amount of points is depleted by a certain amount, and the second person's amount of points is depleted by a different amount not equal to the certain amount. The tallying can include storing an amount of points that each of the plurality of people earn via both online activity and purchasing.

In some embodiments, the certain amount and the different amount each represent a personalized discount that is personalized based on a history of earning points of the respective person. In general, the certain amount and the different amount are determined according to at least one variable for which the first person and the second person have a second value stored in the computer system. Preferably, the at least one variable relates to a rate at which the amount of points is earned by each of the plurality of people.

Offering the incentive can be done by a real-time rewards display such as, for example, by causing a mobile device to display the discounted price. The display can be a real-time price rollback by causing a computer device to display an animation showing the retail price change to the discounted price. The incentive can be offered in-store (e.g., shown on the screen of a shoppers' smartphone or a point-of-sale (POS) terminal) or online.

The process can include mission assignment and mission structures. For example, missions can be assigned to each of the plurality of people, with the points earned by performing the assigned missions. In some embodiments, the missions include purchasing a product and providing to the computer system verification that the product was purchased. Additionally or alternatively, the missions include promoting a product to users of a web site.

Aspects of the invention provide an apparatus for facilitating a purchase. The apparatus has a mobile device form-factor body, a scanning device, and a processor coupled to a memory and the scanning device and housed by the body. The processor is operable to cause the apparatus to scan a product code to determine an identity of a product, determine that a user of the apparatus is a participant in a reward program, display a predetermined discount to the user, and debit a rewards point account of the user a personalized amount of rewards points. The personalized amount of the rewards points is determined based on the user's participation in the program. The scanning device could be a camera or a barcode scanner.

In certain aspects, the invention provides system for influencing a consumer. The system includes a computer device in which a memory coupled to a processor is operable to cause the system to give consumers reward points for performing activities, determine a redemption rate for each consumer, offer the consumers a discount on a purchase, and—for each consumer that accepts the offer—deplete that consumer's reward points by an amount inversely proportional to that consumer's redemption rate. The system settles payment by, inter alia, debiting a selling merchant some or all of a discount amount and crediting a credit card firm such as an issuer some amount. The system may be operable to give the consumers reward points for performing activities that include the use of a social network website and the purchasing of a product.

In some mobile app embodiments, offering the consumers a discount on a purchase is done by providing the consumer with a computer executable application that a consumer can execute on a mobile computing device to cause the mobile device to scan a product code, and displaying on the mobile device a discounted price for product.

In some web embodiments, offering the consumers a discount on a purchase is done by providing the consumer with a product page that a customer views in a browser, and displaying in the browser a discounted price for product.

The system can be operated to perform real-time rewards price rollbacks. Displaying the discounted price can be done by displaying an original price number, displaying a transition, and displaying a final discounted price number. The transition can include an animation of numbers scrolling between the original price number and the final discounted price number.

The system can be operated to perform mission-based embodiments. In mission based embodiments, consumers are given reward points for performing activities that include performing assigned missions. The system can be operated for verifying completion of the assigned missions (e.g., by receiving an image from a consumer). Assigned missions can include recommending a product through the use of a web site. In certain embodiments, the missions are assigned at a frequency that is influenced by a speed of completion of previously-assigned missions.

In certain aspects, the invention provides a system of providing rewards to a user, the system comprising one or more computers operable to store a user profile in a tangible, non-transitory memory (the profile includes a user history and a stored value of reward points), analyze using a processor the user history with a scoring algorithm to provide a score that is indicative of the relative value for the user profile, receive information from a user identifying a product that is available for purchase by a credit card, and offer the product to the user for a discounted price on the condition that the stored value of reward points decreases by a redemption cost inversely proportional to the relative value, wherein the system can also pass discount monies from the merchant to an issuer.

Other aspects of the invention provide a system for providing products. The system includes a computer system operable to tally an amount of points earned by each of a plurality of people, offer an incentive to each of the plurality of people, provide the incentive to a first person while depleting the first person's amount of points by a certain amount, and provide the incentive to a second person while depleting the second person's amount of points by a different amount not equal to the certain amount. Tallying may be done storing an amount of points that each of the plurality of people earn via both online activity and purchasing. In some embodiments, the incentive comprises a discounted price that is lower than a retail price.

In certain embodiments, the certain amount and the different amount are determined according to at least one variable for which the first person and the second person each have a value stored in the computer system. Preferably, the at least one variable relates to a rate at which the amount of points is earned by each of the plurality of people. The certain amount and the different amount may each represent a personalized discount that is personalized based on a history of earning points of the respective person.

### BRIEF DESCRIPTION OF THE DRAWINGS

FIG. 1 illustrates a typical transaction involving a credit card in the invention.

FIG. 2 depicts a simplified net cash flow according to embodiments.

FIG. 3 depicts payment according to certain embodiments.

FIG. 4 illustrates choosing a discount or choosing a number of points.

FIG. 5 illustrates receipt of the mission.

FIG. 6 illustrates a price rollback.

FIG. 7 illustrates social activity.

FIG. 8 shows a mobile device for participating in a rewards program.

FIG. 9 shows a computer device for participating in a rewards program.

FIG. 10 shows a display according to embodiments of the invention.

FIG. 11 shows a display for social media activity for earning points.

FIG. 12 shows a display for identifying a product and shopping for earning points.

FIG. 13 shows a display for receiving a certain discount.

FIG. 14 shows receiving the discount at a different redemption rate by a different user.

FIG. 15 diagrams methods of the invention.

FIG. 16 illustrates identifying a product.

FIG. 17 shows shopping using a device.

FIG. 18 shows viewing a discount via a device.

FIG. 19 depicts components of a system of the invention.

FIG. 20 diagrams components of a system.

### DETAILED DESCRIPTION

The invention provides more than discounts and provides true shopper engagement. Embodiments of the invention do more than provide the customer with valuable discounts. Systems and methods of the invention use a mobile device to engage the customer through an interactive, immersive experience, taking full advantage of in-store assets that include digital signage, in-store Wi-Fi, product displays, product inventory tracking systems and sales personnel.

This invention provides a credit card company with the ability to benefit from giving real-time discounts to shoppers using a mobile or online application that rolls back the price of the item based on the number of reward points redeemed. Reward points are earned through a variety of purchase transactions and social media activities that promote the participating retailers and/or credit card company.

Currently credit card companies can offer customer mobile coupons or gift cards but these promotions are based on past purchased transactions.

Systems and methods of the invention relate to a real-time rewards platform that provide firms the ability to offer product discounts while providing consumers a unique way to earn those discounts. The invention allows a firm operating within a payment system to participate in a platform through which consumers earn rewards points, redeem points, and obtain discounts.

A consumer accesses the rewards platform through the use of a certain credit card, through a mobile app, through online shopping, others, or a combination thereof. In some embodiments, the consumer uses a mobile app operating on their smartphone, tablet, or other computing device. The mobile app may be provided by, or associated with, a firm operating within a payment system. In certain embodiments, that firm is a player within a credit card payment system and can be any of an acquiring bank, a network, or an issuing bank. For illustrative purposes, operation of the invention is described with the participation of a credit card issuing bank, or “issuer”.

In some embodiments, the issuer provides a mobile app for use by the consumer. The consumer uses the mobile app to participate in the rewards program and earn points (or miles) from both purchase behavior and social activities. Additionally, the reward program can include missions. For example, when shopping, the customer may be sent missions based on: location (visit coffee chain on 44th and Third Ave and upload a picture from inside the store for 10 points); past purchase preferences and next logical product (pre-mapped by participating retailers); real-time Offers from retailers either fully or partially funded by manufacturers (visit coffee chain on 44th and Third Ave and buy a $3.50 beverage for 10% off and earn 50 points); selection of a quest (e.g., visit five participating women's clothing retailers within 10 blocks between 1:00 and 5:00 on Sunday, June 4 and earn 300 points; others; or a combination thereof. In some embodiments, quests or missions are in sync with pre-planned in-store promotions at those retailers.

Systems and methods of the invention can be operated to a pull a customer to a participating merchant. For example, when the customer scans a bar code on a product while visiting a retailer, the app pings a database administered by an admin of the rewards program. If the retailer is not participating in the program, the mobile app lists retailers that are participating in the program selling the product and displays for each one, level of discount and points available to earn (e.g., if the product is purchased within “x” hours/minutes of the scan). In some embodiments, the app lists participating retailers by proximity.

When the customer decides to purchase the product from a participating retailer, the customer may scan the bar code; select one of three discount levels offered; pay with an is suer-branded credit card registered to the mobile app and then receive an automatic confirmation of the final price paid (that will appear on their statement) and watch the price roll back on their mobile device. The customer may also watch points being added to their balance and they may also receive a mission or offer related to their purchase to encourage an additional sale or other behaviors. Embodiments of the invention include communities, in which customers are able to join a community they have the most affinity with. (NYC Teachers, Blondie Fans, Volt Nation, Lady Gaga Followers etc.) via, for example, a FACEBOOK login. Depending on the group they join, missions and quests are automatically sequenced and calibrated based on factors such as the customer's social index, past credit card shopping behaviors, locations in real time, others, or a combination thereof. As the customer completes missions or quests, they earn points and when they go to redeem, the amount of points required for a specific discount are determined by co-efficient algorithms, and rules defined by the credit card Program. In some embodiments, a top quartile leaderboard level customer receives an “override co-efficient” that decreases their points requirement even more in recognition of their participation.

The invention provides an integrated view of three elements: past purchase preferences, location and social activity. The combination of these three data points provides a comprehensive view of consumer purchase behavior that is unique in the rewards industry.

Key features of the invention platform include location-based alerts; missions, quests, levels and leaderboards; real-time discounts; and event-driven offers.

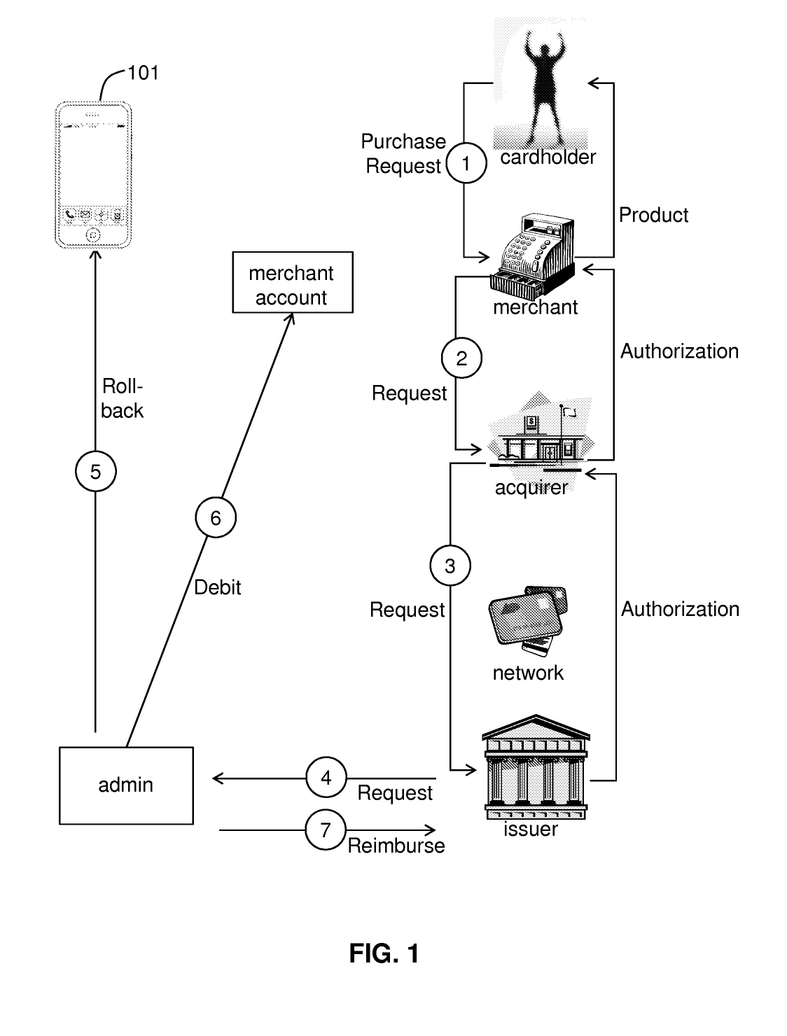

FIG. 1 illustrates a typical credit card transaction. A cardholder first makes a purchase request to a merchant, offering to pay with their credit card. After a merchant swipes the card, at step 2, a request is submitted to merchant's bank, called an acquirer, to request authorization for the sale. Typically, the acquirer is a bank that processes and settles a merchant's credit card transactions with the help of a card issuer. At step 3, the acquirer then routes the request to the card-issuing bank (“issuer”), where it is authorized or denied, and the merchant is allowed to process the sale. The issuer at step 4 sends a request to an admin of systems and methods of the invention (in some embodiments, the admin administers a rewards program and has a pre-existing relationship with the issuer by which the issuer's cardholders are participants in the rewards program and may have cards branded with the rewards program). The admin at step 5 causes the consumer's device 101 to show that the consumer will be receiving a discount (e.g., by an animated price change or rollback). The admin at step 6 debits an account of the merchant by an amount that includes at least part of the discount cost and may include the full discount cost plus an administrative charge (e.g., 10% of any discount). At step 7, the admin credits the issuer with the amount of the discount. Later parts of processing a credit card include batching. At the end of a day, the merchant reviews all the day's sales to ensure they were authorized and signed by the cardholder. The merchant then transmits all the sales at once, called a batch, to the acquirer to receive payment. Card networks such as, for example, VISA or MASTERCARD, act as an intermediary between an acquirer and an issuer to authorize credit card transactions. Clearing may be the third step in processing a credit card. After the acquirer receives the batch, it sends it through the card network, where each sale is routed to the appropriate issuing bank. The issuing bank then subtracts its interchange fees, which are shared with the card network, and transfers the remaining amount through the network back to the acquirer.

Location-based alerts are provided. Using resources such as in-store Wi-Fi, the invention provides the opted-in retail customer with real time alerts when she comes within a few feet of products that are either in her online Wish List, saved in her shopping cart or items as a likely future purchase based on past purchases.

The invention includes missions, quests, levels and leaderboards. To make it easy to earn reward points, the invention may provide customers with missions and quests. A mission may be a time-based challenge, sent to the customer that allows the customer to earn points that can be redeemed later. Any suitable activity can be included in a mission such as, for example: physical actions such as bringing someone shopping with you or attending an event; social actions such as tweeting, answering a survey, comments or “likes” on social network page; advocacy actions such as re-tweeting or commenting about a purchase on another person's social networking page; uploading a picture or video while shopping to the social networking page of another customer or of a retailer; purchasing a new item at full retail price; others; or a combination thereof.

In a preferred embodiment, quests are a series of connected missions that allow a customer to earn accelerated points. A quest assigned to a customer by a retailer could include visiting several departments in a store and scanning a QR code on products located in each department as proof of completing the quest. For a gaming company it could include playing three or more games or visiting different venues across designated locations. Quests may be reserved for rewards customers participating at the highest tier of the program. One key may be that the invention helps the customer co-create an experience that ties rewards to incremental behaviors.

Once the customer has accumulated enough points, they reach advanced levels that make greater discounts and rewards available to them. As they earn more points, they climb leaderboards specific to their areas of interest. the invention works with the retailer to align these gaming levels to any current rewards levels in their existing program.

Embodiments of the invention include real-time discounts. During their shopping experience, the customer is able to apply the rewards they have earned toward their purchases. A retailer may offer a discount in any suitable way such as, for example, a fixed discount or a maximum discount.

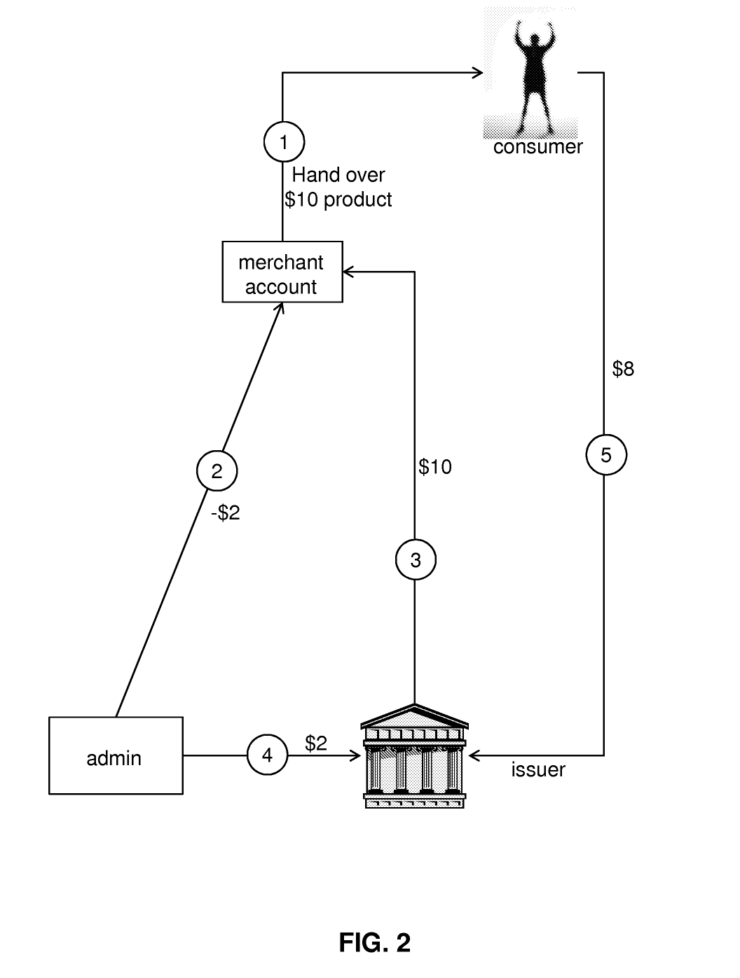

FIG. 2 depicts a simplified net cash flow (with any interchange fees or admin charges omitted for clarity). Using the system depicted in FIG. 1 to accomplish these net flows, a consumer visits a merchant and is given a $10 product at step 1. The consumer “pays” with a credit card. An admin that is administering systems and methods of the invention then debits the merchant's account by an amount of a discount at step 2. In the depicted example, the consumer is obtaining a $10 product subject to a 20% discount, so the consumer expects to pay $8 for the product. Once the admin receives the request from the issuer (as depicted in FIG. 1), the admin debits the merchant's account by the discount amount (i.e., the merchant account balance changes by −$2). As per traditional credit card settlement systems, at step 3, the issuer sends the $10 retail price to the merchant. While the numbered steps do not have to performed in any specific order, in the depicted embodiment, at step 4, the admin credits the issuer with the discount amount. Then, at depicted step 5, the consumer pays their $8 credit card bill. The issuer may print the bill to include a $10 charge, a −$2 discount, and a $8 balance due.

In some embodiments, the admin will take a small credit on every transaction. For example, if an admin contracts to take 10% of each discount from the retailer, then in depicted step 2, the admin would debit $2.20 from the merchant account. Other admin credits are within the scope of the invention. For example, the issuer may agree to share the admin charge, and depicted step 4 could be lower than $2 by an agreed-upon amount.

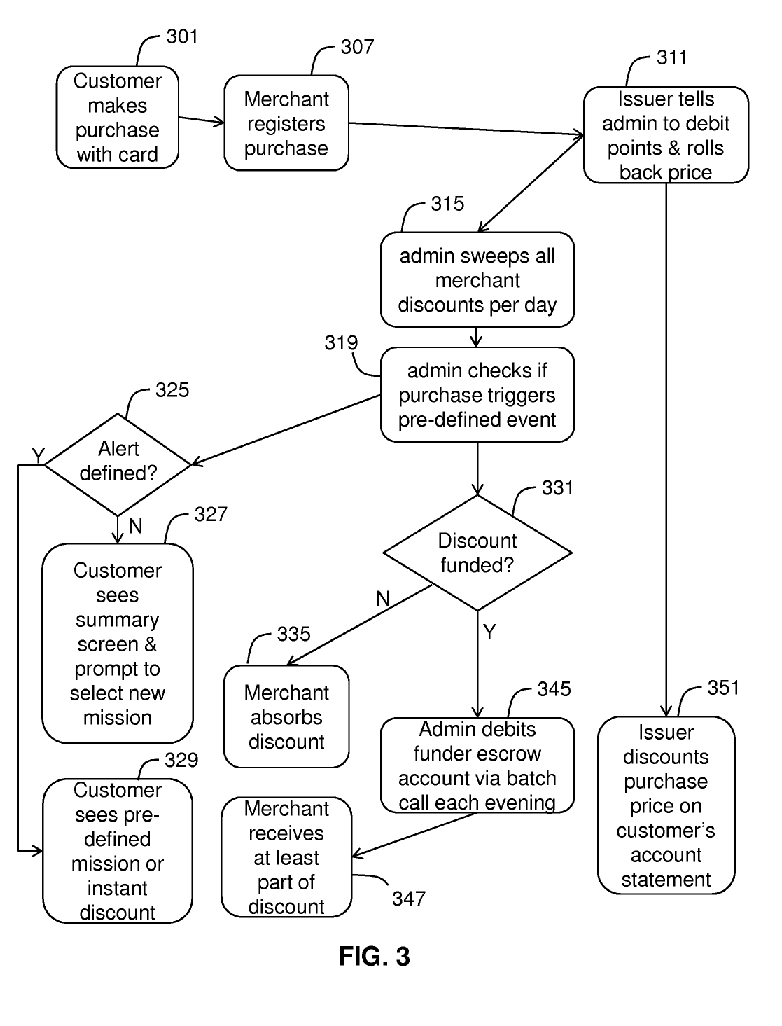

FIG. 3 depicts payment according to certain embodiments. Methods begin when a customer purchases 301 an item with a credit card. The merchant registers 307 the purchase. Where a payment system firm (e.g., issuer) participates, the issuer then tells 311 the admin to debit the customer's points and roll back the price. The admin receives the request from the issuer indicating a transaction has occurred (e.g., the request including the customer's cell number, the amount, the accepted discount level, etc.). Optionally, the admin may determine 325 if an alert is defined and—if an alert is defined—the customer may see 329 a predefined mission or instant discount. Else, the customer may see 327 a summary screen with a prompt to select a new mission.

The admin then rolls back the price on the customer's mobile device along with a message indicating that this is the price that will appear on their credit card statement. The mobile device may identify itself to a system of the invention, and thus identify the participating customer, by phone number, MAC address, IP address, other unique identifier, or a combination thereof. The admin then determines 331 if the discount is funded, at least in part, by a third party such as a wholesaler or manufacturer. If the discount is not funded, the merchant then absorbs 335 the discount. If the discount is funded, the admin debits 345 the funder's account and the merchant receives 347 at least part of the discount. The admin may charge any party an admin fee at any depicted step. The consumer is reminded of the discount when the issuer discounts 351 the purchase price on the consumer's credit card account statement.

Using systems and methods of the invention, customers achieve actual discounts in real time and can tangibly experience the relationship between their social and buying behaviors on the discounts they are able to achieve. The invention allows retailers to modify and optimize the program based on current and predicted consumer behavior. Embodiments of the invention allow customers to shop across many retailers and earn and redeem rewards across different retailers.

Novel features of the invention may be found to include: sending customers missions or quests based on location, preferences culled from a proprietary social index, and past purchases; providing a list of nearby retailers offering discounts on a scanned product and the reward points to be achieved if purchased; climbing an affinity based leader board based on social and purchase behaviors; providing real time price roll back on the device 101 once the discount level has been chosen and the points used to get the discount have been redeemed; providing the issuer data on customer behaviors based on location, spending habits/preferences and social activity; and others. Using systems and methods of the invention, consumers will save money. Retailers will gain incremental sales. Credit Card companies will achieve more card usage and loyalty.

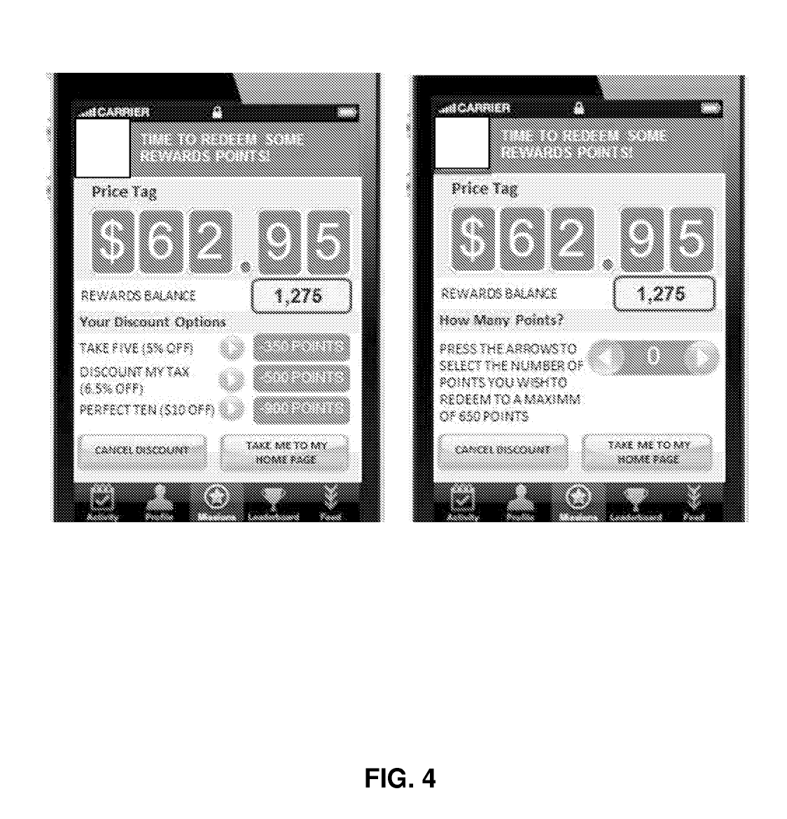

FIG. 4 illustrates choosing a discount or choosing a number of points. A fixed discounts provides the customer with, for example, three fixed discounts they can redeem a displayed set of reward points against. A maximum discounts option allows the customer to choose the number of points they want to redeem toward a maximum discount level. In both cases, the customer watches the price roll back before their eyes once they have finished scanning the item bar code.

Event-driven offers are provided by the invention. Customers may opt in to be provided real time offers during their shopping experience. These offers are triggered based on a number of criteria such as a purchase, a location, or a sales event. A purchase may trigger an offer. For example, if the customer has scanned a pair of jeans she wants to purchase, she may be offered a matching top that will earn her rewards points. Location can trigger an offer. The customer is passing by an item that history or previous browsing behavior suggests she might have interest in and the retailer is interested in selling it before sending it to clearance. An offer may be triggered in connection with a sales event. The retailer is promoting a specific line or new product promotion and wants to offer all opted-in customers the chance to get a great deal. By these means, the invention may put the excitement back into shopping for the consumer, while dramatically increasing traffic, conversion and average ticket for the retailer.

An illustrative example will illustrate the invention in action.

Let's look at an example. STORE (a hypothetical department store) is a US retailer working hard to restore its position as America's Favorite Store. Let's imagine how the invention could help their transformation by engaging their target customer and leveraging their current STORE Rewards Program.

Imagine a hypothetical first consumer participating in the rewards program named Christine. Christine thinks of STORE as her Mom's store. As a kid it was about Saturday afternoon mark downs, the hunt for the best deal on jeans and a chance for a donut and a coke in the mall when it was over. While on a social networking site, Christine noticed her friend, second consumer Tabatha, “likes” STORE, so she goes to STORE.com to check it out.

Social behaviors include a hypothetical instance of second consumer Tabatha commenting on STORE on a social networking site. Christine notices that the store offers $35 dresses and thinks, “nice”. Christine registers on the site and puts a scallop lace dress in her shopping bag. After signing up for STORE Rewards Christine downloads the STORE mobile app. She texts a second customer Tabatha to see if she wants to go to STORE tomorrow—say around 2 PM? It's a date.

While waiting for Tabatha at a coffee shop (which may itself be a participant in the rewards program), Christine receives a text message from STORE. A discount for ‘friends and family’ she can use today and through the weekend. She and Tabatha go into the STORE. As Christine approaches the dress department her mobile phone alerts her that she is near a product in her shopping cart: the scallop lace dress. They try on different dresses. The STORE sales person helps them find their sizes and recommends different accessories. This is not her mother's STORE!

Based on operation of systems and methods of the invention, a participant may become a new customer. Christine buys the dress applying the “Friends and Family” coupon and while paying at a self-checkout station she immediately receives a “Mission” from her STORE mobile app: “Thank you for your purchase! Add a pair of shoes valued at $20 or more to that new dress and we will double your reward points!” This is an example of the first consumer being sent a mission by systems and methods of the invention.

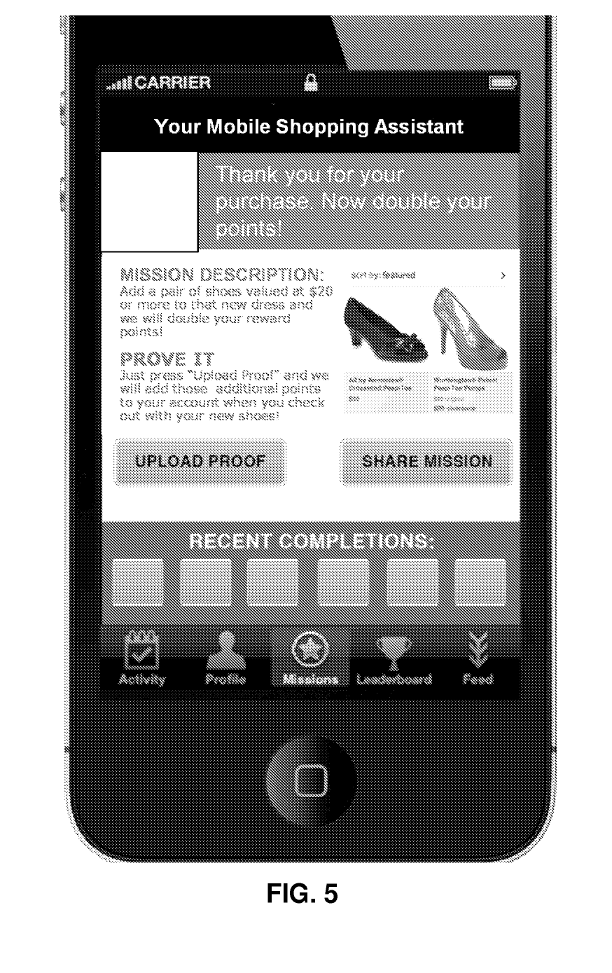

FIG. 5 illustrates receipt of the mission. Those orange peek toe shoes are perfect! Christine adds the shoes and watches the additional points get added to her rewards account to be redeemed next month!

The invention offers discounts when a participant determines that it is time to redeem points. Christine was back at STORE the next month to apply the rewards she had earned from the previous activity. She decided to buy a second dress from the same designer and watched 5% roll back off the retail price before her eyes! It felt GREAT!

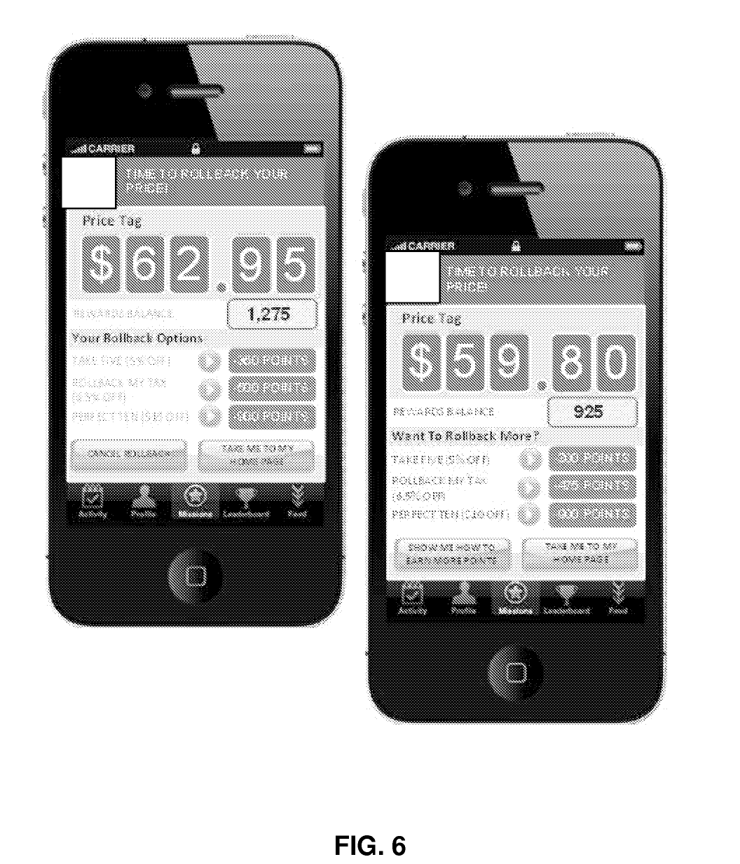

FIG. 6 illustrates a price rolling back right before a consumer's eyes.

Based on operation of systems and methods of the invention, a participant may go from being a customer to being a customer and an advocate. Three months later, Christine is a STORE fan. She has joined the STORE Shopping Diva program and is earning points when her friends and family use her personal discount code!

Christine has “liked” STORE on her social networking page and when she receives a mission to tweet about a new STORE event, she doesn't hesitate. Christine can't imagine living without STORE! In fact, Christine's friend Jennifer, a hypothetical third customer, just read Christine's tweet about STORE. Funny, third customer Jennifer recently booked a trip to Barbados and was about to go shopping for a new bathing suit . . . hello STORE.

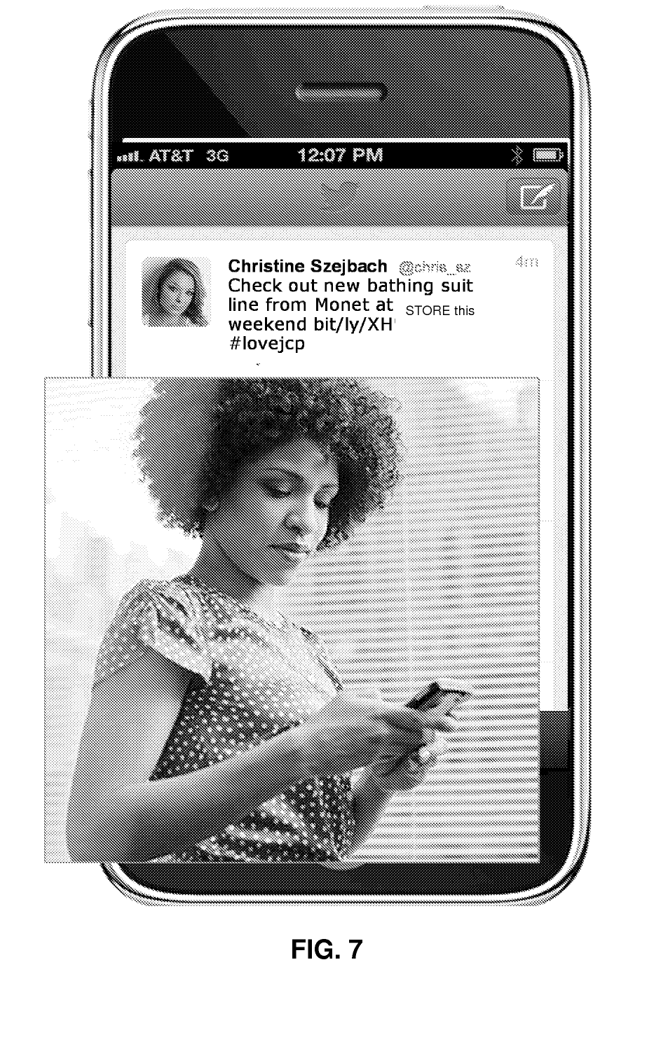

FIG. 7 illustrates a consumer tweeting about STORE. One of skill in the art will understand that the preceding example was non-limiting and illustrative.

This scenario describes the experience of one customer. A program of the invention may include 50,000 more such customers. Or perhaps 500,000, or 5 million. A plurality of involved customers has such implications as purchase consolidation; reduced advertising spending; predictive analytical tools; and optimized gross margin for retailers.

In some embodiments, the invention encourages purchase consolidation. As rewards customers such as Christine get used to seeing their social behaviors and purchasing loyalty rewarded with consistent actual savings, they consolidate their purchase occasions to those retailers who's rewards program are powered by the invention.

In some embodiments, the invention saves on advertising costs. Because social behaviors are such a big part of earning points, customers become the biggest source of marketing word of mouth, reducing traditional advertising spending, instead, allocating those dollars into discounts that that the customer values and is motivated to promote with her friends.

The invention includes valuable predictive analytical tools. As Christine responds to specific types of missions, the invention gets smarter and personalizes the types of missions, the number of missions, even the time of day that missions are sent to her. Over time, across millions of customers, the retailer can start to predict the response to specific types of missions, suggesting to their store operating counterparts what times of day on a given week they should expect greater traffic, in what parts of the store.

Embodiments of the invention optimize gross margin. Most importantly, because of the invention's patented rewards redemption engine, the customer maintains a point level that keeps her coming back that is balanced by the retailer achieving the maximum gross margin based on volume and inventory turnover targets.

Aspects and embodiments of the invention calculate personalized points redemption in real time. Generally, when a customer scans a product, the invention conducts a real time analysis of several data sources that may include any one or more of: a points balance; types of points earned; frequency at which points have been earned; amount of social network activity in a period of time; time since the last transaction; time of day; location, and company defined discriminant factors (such as status in the rewards program).

Based on the weighted performance across these and potentially other factors, the invention allocates the number of points that are required to achieve each of the available discounts.

The retailer decides how many points are allocated to each “Earning Behavior” so the way you reduce the required redemption amounts is totally transparent to customers. In fact, it is promoted to drive participation. Although missions expire if not acted upon, breakage is discouraged as the goal is to ensure these customers are earning and redeeming frequently as well as driving up traffic, conversion and average ticket. Any suitable business rules may be implemented. For example, a business may allocate the granting of points to a customer for any shopping or promotional activity however the business sees fit (a min % for promotional and a high % for shopping, or vice-versa).

As an illustrative and non-limiting example, consider two customers: a first customer Christine and a second customer Martha. Christine has been using the invention for a while and has accumulated 1,010 points. Table 1 shows a breakdown by which Christine, a hypothetical first customer, has accumulated points. Thus in table 1, a retailer can adjust the points appearing in the “Points” column and can grant points to any suitable promotional or purchase example as listed in the first column.

TABLE 1
Breakdown by which a first customer has accumulated points.

| Missions | Points | Number | Total |
|---|---|---|---|
| Social (Tweets, Facebook Updates etc.) | 5 | 20 | 100 |
| (Any suitable promotional activity) | X | P | X × P |
| (Any suitable purchase activity) | Y | Q | Y × Q |
| Purchase in-store item at full price | 20 | 5 | 100 |
| TOTAL POINTS | | | Σ |

A hypothetical second customer named Martha has not been as active in the program. Table 2 shows an alternative breakdown by which a second customer may have earned points.

| Missions | Points | Number | Total |
|---|---|---|---|
| Social (Tweets, Facebook Updates etc.) | 100 | 20 | 2000 |
| (Any suitable promotional activity) | X | P | X × P |
| (Any suitable purchase activity) | Y | Q | Y × Q |
| Purchase in-store item at full price | 5 | 5 | 25 |
| TOTAL POINTS | | | Σ |

Both women are interested in purchasing the same item: some fashion jewelry that retails for $18.00. The “baseline” points required for a first customer to get one of three discounts are shown in Table 3. A different customer may be required to redeem a different number of points.

TABLE 3
baseline points required to get one of three discounts.

| Discount | Baseline Points Required | Discounted Price |
|---|---|---|
| 5% Off | 50 | $17.10 |
| 7% Off | 70 | $16.74 |
| 10% Off | 100 | $16.20 |

Given the social and purchasing behavior of the first customer and second customer, the invention address how many points it will take for each of them to achieve any of these three discount levels. Once they each scan the product and select the discount level they want to apply, the invention's business rules engine displays the points required from their rewards account to achieve it.

Applying the invention's real-time redemption allocation engine, the performance both customers have achieved is determined against the business rules described and the co-efficient applied to the baseline points is determined to calculate their individual redemption points required. Table 4 gives points requires for the first customer and the second customer to receive certain discounts.

TABLE 4
Points requires for the first customer and the second customer
to receive certain discounts

| Points Required | Baseline | Christine | Martha |
|---|---|---|---|
| To receive a 10% | 100 | 69 | 90 |
| discount | | | |
| To receive a 7% | 70 | 48 | 63 |
| discount | | | |
| To receive a 5% | 50 | 34 | 45 |
| discount | | | |

By being an active the invention participant, Christine (the first customer) is able to achieve the maximum discount while redeeming fewer points than Martha (the second customer). It's enough to make her tweet about it, upload a picture of the new jewelry, bring a friend to the store on her next visit and buy an additional item recommended to her by the invention that matches her new purchase and earn double the points!

The invention provides systems and methods by which a retail may increase sales and gross dollars by making modest sacrifices in margin. For example, in some embodiments, a retailer could trade a small number of percentage points in retail gross margin in order to drive up sales and gross margin dollars.

Adding in the expense savings from the lower cost of marketing and this investment becomes even more impressive when considering net income. Finally, if the discounts provided can be underwritten, or shared with manufacturers' providing the products, the invention represents a way for a retailer to achieve significant profit performance improvement.

Systems and method of the invention include an architecture that is composed of such elements as a gaming creative suite; calculating a personalized discount in real-time; a POS Interface; a business rules engine; predictive Analytics; a reporting dashboard; a settlement system; integration APIs; others; or a combination thereof.

With a gaming creative suite, the invention's gaming features allow the user to develop specific missions, quests and levels based on the business objectives of the company. Leaderboard templates can be selected from, and tailored to specific groups or products.

Calculating a personalized discount in real-time means that the program literally discounts the price before the user's eyes, based on a real time allocation of points toward a specific purchase. The number of points required to achieve a specific discount level changes based on a unique algorithm that creates a point allocation from previously describe criteria. An additional feature for companies that are trying to sell a particular item is an ‘instant offer’. This is a discount provided beyond the standard three choices designed to motivate the user to make that purchase immediately. It is time-based and provided as a ‘surprise’. Once the offer expires it is not available. It is also linked to the shoppers online “Shopping Bag” or from previous scans and can be offered before selling to wholesalers or sent to the outlet center to maximize profit per item.

A POS Interface means the invention works with any product or point-of-sale system by simply scanning a bar code or QR code on the item or on the bill for the item (such as a restaurant receipt). The built in scanner that is part of the application captures the price reflected on the bill, or the item and calculates the discount based on the above criteria in real time. The customer presents the discount code generated to the cashier or their smart phone is scanned by the POS System Reader.

A business rules engine may increase or decrease the frequency of missions based on a set of algorithms that include speed of completion; threshold of type; location access (e.g., by Wi-Fi); or others. The user's speed of completion may indicate that users who accept and complete missions quickly will be sent new missions at a greater rate until their completion speed changes.

A maximum threshold of each ‘type’ of mission is set at the beginning of the program to allow the program sponsor to predict and manage their discount liability The type of mission completed will trigger a sequence of linked missions based on the completion of prerequisite missions. For example, a customer sent a mission to upload a picture to a social networking site that does not respond across a time period is not sent further social-networking related missions unless their profile changes with a social networking site login. However, if they complete a mission to send a tweet, this will trigger more missions suggesting tweeting until their response to those missions changes. Companies can also design missions based on in-store business rules. For example, if the customer purchases jeans or scans the item's bar code, a pre-defined top is recommended with an incentive for immediate purchase.

Depending on the level of Wi-Fi onsite, their location will also trigger a specific type of mission based on their location in the store or venue. These missions are also triggered based on their location and businesses where they have “checked in” (e.g., Facebook) or have “mentioned” on a social commentary site.

Predictive analytics is provided. The invention includes a unique data analytics module that gathers the results of missions completed by all of the users participating in the program and provides insight into which missions achieve the greatest response and what levels of discounts offered create the most significant behavior change, especially in both purchase behavior and social advocacy. Secondly the company's designated administrator can conduct an analysis of price and volume performance on product categories for their competitive set and see where they rank across a set of criteria. the invention also provides the marketer with next logical product offers to customers and third parties (e.g. social networking ads) based on mobile scanning history that did not lead to conversion. the invention uses data mining of the consumers' social activities and purchase and browsing behaviors and then provides the marketer the ability to choose the social channels that specific customer segments are demonstrating and are most relevant to them thereby improving the ROI from social marketing. Over time, as the database of rewards customers grows and a history of responses to specific types of missions to specific types of customers is analyzed, the analytics module will be able to forecast visits, conversion and average ticket by time of day and day of week within an ever more accurate margin of error.

A reporting dashboard may be included. The online reporting dashboard provides both executives and operational managers with the insight into the data they need to understand how to make adjustments to the program to drive incremental same store sales.

A settlement system is a valuable feature. As with any rewards program, those companies that choose to provide financial rewards need to settle the pay back of those dollars to the companies funding the discounts. For example, if Panasonic agreed to fund the discount for the purchase of their Digital TV at a Best Buy Store, the invention's settlement system balances those accounts and creates withdrawals and deposits via escrow account calls at the end of a sweep of participating companies' POS Systems that occurs at a pre-defined interval.

Integration APIs may be included. Finally, many retailers have established systems that the invention may need to share data or application information with, a SDK of API's have been developed to ensure data passing from the invention to other systems seamlessly.

The invention address problems known to be associated with prior art loyalty programs.

The invention addresses the two primary needs consumers want from a loyalty programs: instant discounts and points that can be redeemed for products and services.

The invention is focused on a retailers most valuable customers that are already heavy to moderately frequent shoppers. The goal of the program is to provide consistent savings to customers that advocate for the company and shop frequently. The invention provides more than a loyalty program. It uses the customers' mobile device as a shopping concierge to make the browsing and buying experience an adventure, packed with surprises and offers that make going back to the mall fun again. Customers that opt into the invention aren't just shopping, they are on a mission!

The invention customers learn that their own social and purchasing behaviors control the points required to achieve consistent discounts on the products they care about from the retailers they love. Also, since it is a mobile device with a scanner, comparison pricing is a click away. The value from the invention is front and center and completely transparent to the consumer.

The invention provides a mobile-powered rewards program that allows the consumer to actively participate in deciding the number of points to redeem in order to achieve one of three possible discounts. In certain embodiments, the invention provides a mobile-based loyalty program that allows customers to earn redeemable points through both purchasing and social behavior. Points may be redeemed for incentives. Incentives may include products, discounts, favored treatments, services, others, or a combination thereof. Preferably, an incentive is given to different customers at personalized point costs, and the point costs can be determined based on each customer's history of participation in the program, earning points, shopping, social activity online, or a combination thereof. Determining a personalized point cost can be done by calculating a formula, looking up values in a table, receiving extrinsic input, or making reference to a discriminant factor.

In a preferred embodiment, points are redeemed in real-time by a person through their use of a computer device or mobile device. For a given purchase, point redemption can be done in any suitable way including, for example, via a merchant's point-of-sale (POS), in online shopping, or through use of a mobile device. In some embodiments, a person can redeem points using their mobile device to identify a product (e.g., by scanning a product or service code such as a bar code or QR code) and being offered, via the mobile device, an incentive. The incentive can be presented as a discount on the purchase (purchase can refer to goods, services, or both). In some embodiments, presentation of the discount is done by a real-time display. The consumer opts to engage the rewards program and views a purchase with price on a computing device. A discount incentive is offered in the form of the original, retail price transitioning to the discounted price (e.g., as a “rollback”). Additionally, in some embodiments, discount amounts can be selected by consumers by selecting a number of points to redeem.

Systems and methods of the invention provide useful benefits to consumers and merchants. For consumers, the invention provides consumers with a way to achieve significant savings based on both their shopping and social behaviors. Additionally, as discussed herein, participating in missions and social activities can be engaging and interesting in their own right. Further, by promoting and communicating about goods and services within the context of a rewards program, consumers are disseminating actionable information about the availability and desirability of goods and services to other consumers. Retailers, both online and in-store, are given a powerful tool for conversion (turning browsers into buyers). Due to the fact that a retailer can engage the rewards program to offer a discount in real time and in response to a consumer's inquiry, retailers can use tools of the invention to influence consumers who are “on the fence” without having to run an indiscriminate sale. Moreover, retailers can use system and methods of the invention to tailor offerings to consumers, as well as their interactions with consumers, to achieve the sales goals of the company for that particular product or service. For hospitality or entertainment companies, the invention provides their guests with a positive experience that drive up transaction volume, spend per visit, repeat visit and positive social advocacy.

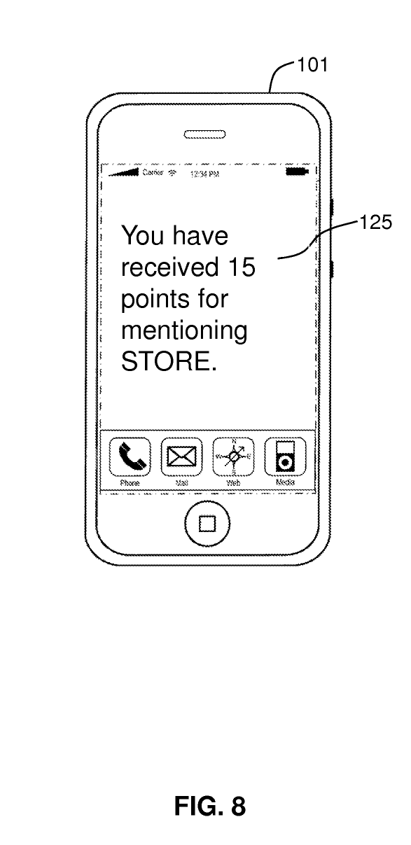

FIG. 8 shows a mobile device 101 for participating in a rewards program. In some embodiments, a user will register for, or sign up for, ongoing participation in a rewards program. Registration is preferably done via user of a computer such as a mobile device 101 or through a web page. Registration and other functions of the invention described herein can be accomplished through use of a display 125 to interact, via a mobile app, web page, or other command structure, with program. In some embodiments, rewards points are earned for registering for the program, for downloading the mobile app, or for other activities, such as for first accessing a web page, or for use of a web page.

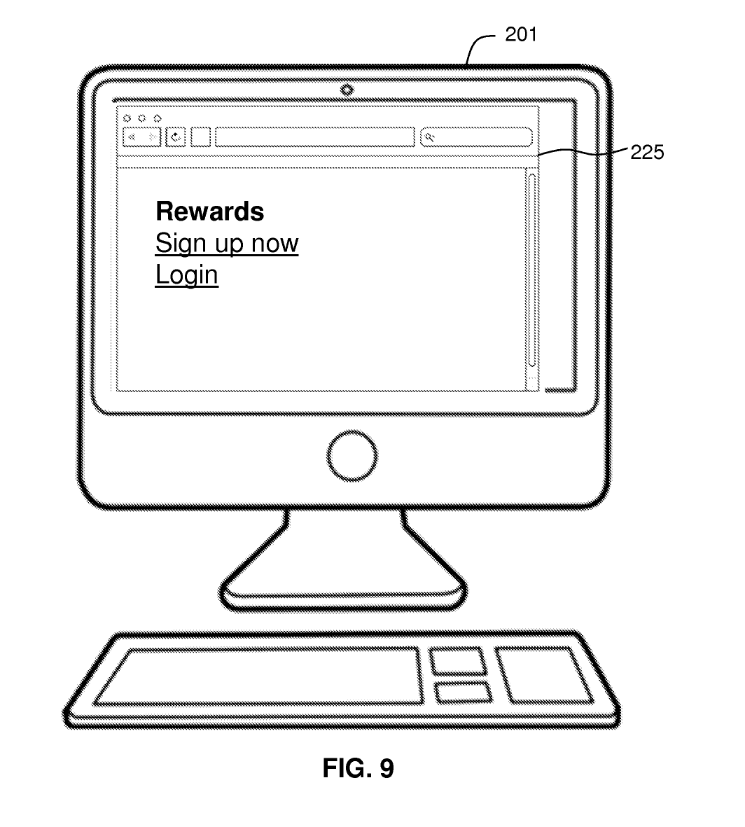

FIG. 9 shows a computer device 201 with display 225 for participating in a rewards program. Display 225 can be provided using a web page, a dedicated computer application, via email, or other methods and systems. As shown in FIG. 2, a consumer can use display 225 to log in to an account or to sign up for a rewards program.

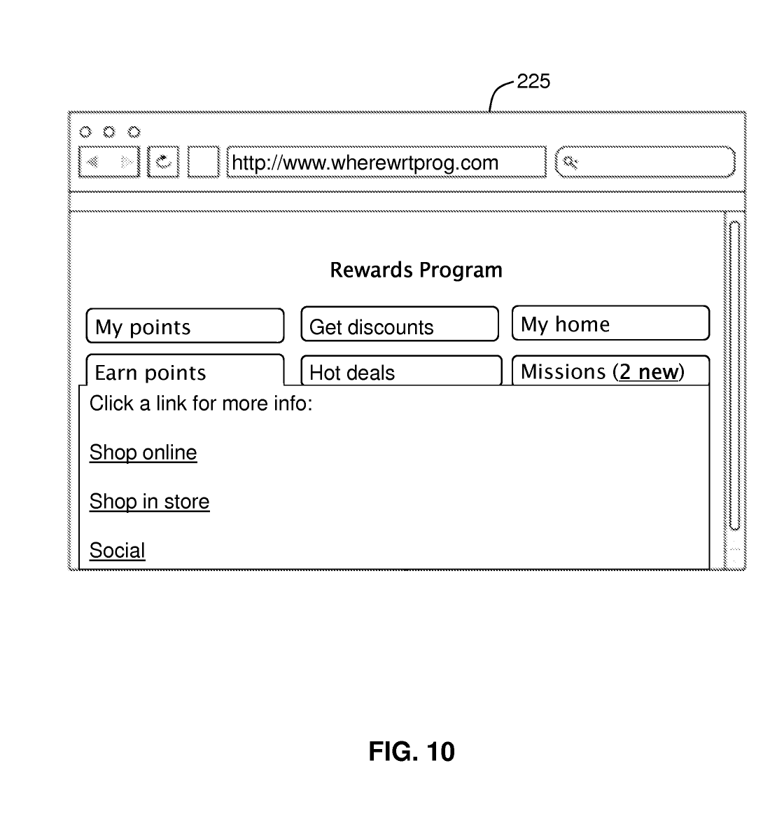

FIG. 10 shows a display according to embodiments of the invention. In some embodiments, a rewards program uses a web-based account and home page. A consumer may log into their account and view the home page to initiate activities described herein. Rewards are earned through online activity such as through the use of social media web sites and also through purchasing activity such as through buying products in stores and online. In certain embodiments, a rewards program includes a mission component.

A mission component can be used to structure a consumer's participation in a rewards program according to gaming experiences. A participant can be included in ongoing or interactive tasks, which may be referred to as missions. Missions can be created by participating retailers or service firms (e.g., hospitality firms) or can be created by administrators of the rewards program itself. The invention provides a mobile rewards solution that allows a user to earn reward points from both purchase behavior and social behavior and redeem them for real time discounts in retail, online and mobile settings. Retailers or hospitality customers can also provide their customers with non-financial rewards based on purchase and social behaviors such as preferred seating at an event, moving the front of a line at a theme park or choosing from low cost complimentary merchandize. As with redemption rates (discussed elsewhere herein), mission assignment and non-financial rewards can be determined based on a value or status of a consumer or their profile. For example, redemption rates, non-financial rewards, mission assignment, and other offerings of the program can be based on a level of points achieved, a user's status on a leaderboard after a specific time period, or other factors. In some embodiments, missions are time-based and must be complete within a specific time window.

Generally assigning a mission will include providing a consumer with information identifying at least one task to be performed and instructions on how to verify completion. For example, a mission can be assigned by letting a user click a link to open a new mission, or by emailing a mission to a consumer. The mission can give, as a task, that a consumer is to refer to a certain product online. The rewards program can verify completion by having the consumer allow access to a consumer's information within a third-party social networking site. When the consumer mentions, links to, review, or “likes” the certain product within the third-party social network site, the rewards program server receives and notes verification of mission completion.

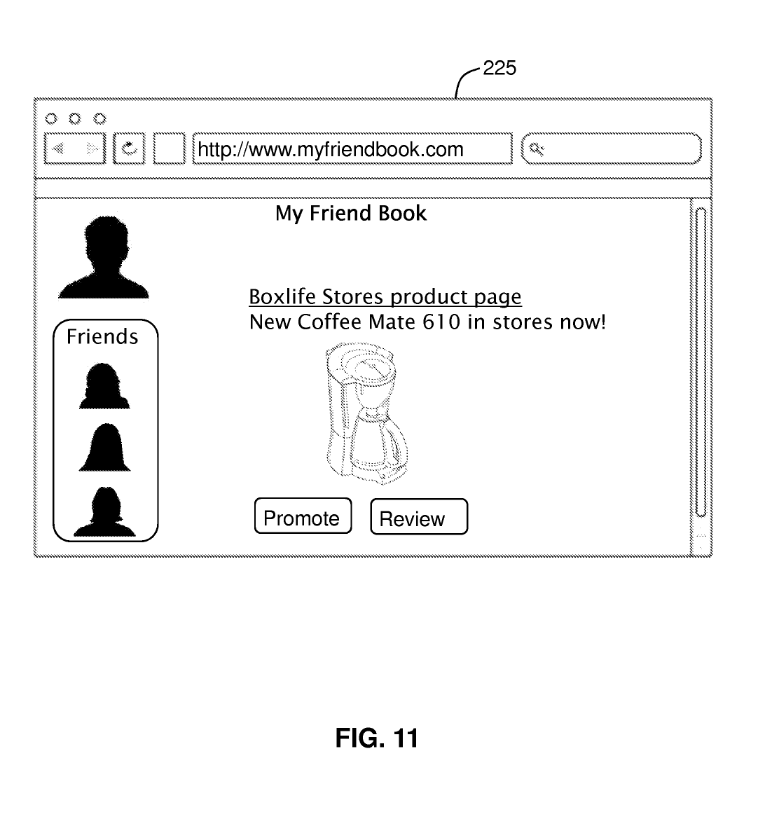

FIG. 11 shows a display for social media activity for earning points. Here, the display 225 depicts a consumer having been given a mission to promote a product (e.g., a coffee maker) on a social media web site for a certain number of points. In some embodiments, a mission could include a second activity component (e.g., an optional one) such as writing a full review for additional points. When the user promotes the product, code is executing information a server system that the user has completed the mission. The program server system—keeping a running tally of the user's points—can then increment the tally the appropriate amount.

Additionally, besides just social activity, purchasing activity can earn points in a rewards program of certain embodiments.

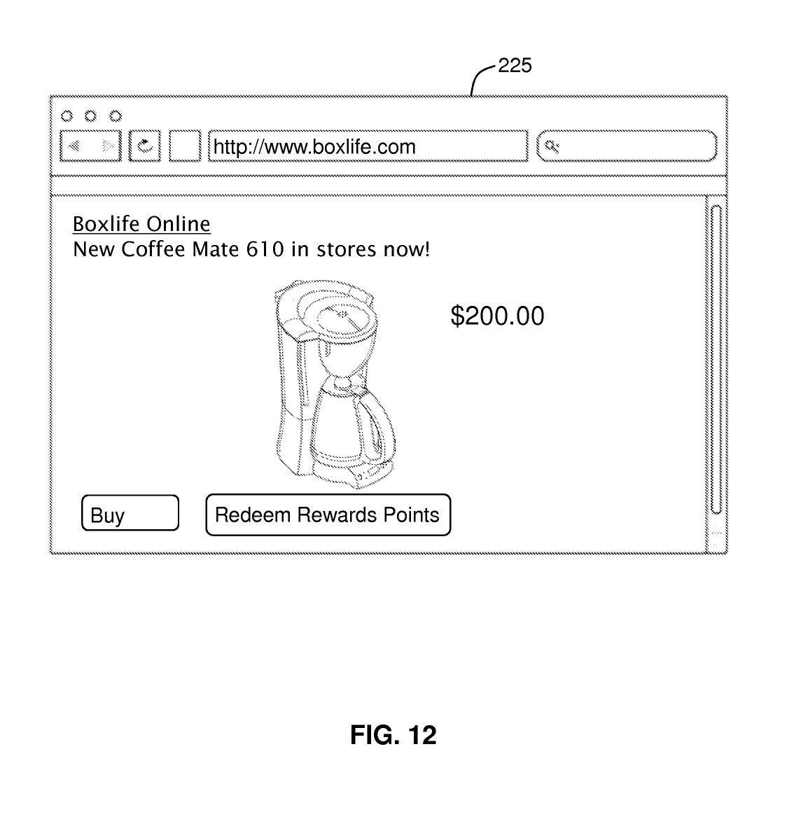

FIG. 12 shows a display for identifying a product and shopping for earning for earning points. In the depicted display, a consumer has gone to a retailers web page for making online purchases. In some embodiments, the retailer and the rewards program administrator cooperate. In certain embodiments, a retailer administrates a rewards program of the invention or a component of it. A user can purchase the product (e.g., at the offered amount) to receive rewards points.

Further, a user can redeem points for incentives such as discounts, giveaways, and services. As shown in FIG. 5, a product can be purchased by redeeming rewards points (e.g., to get it for free or at a discount). In preferred embodiments, systems and methods of the invention are used for calculating a personalized discount. As shown herein, the invention can be used to discount a price before a user's eyes based on a real time allocation of points toward a specific purchase. Further, a discount can be offered equally for different users, but can be personalized via a personalized redemption rate.

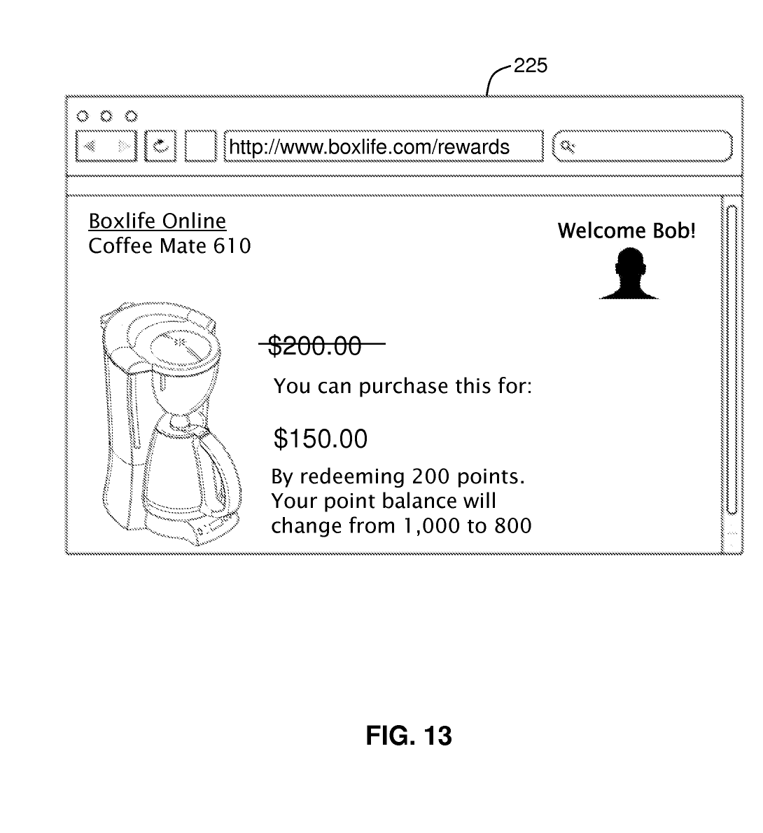

FIG. 13 shows a display for receiving a certain discount at a personalized point redemption rate. As shown in FIG. 6, a user (e.g., “Bob”) can redeem points to receive a discount. The user may be offered a certain redemption rate such as, for example, 200 points for a $50 discount. While not shown in FIG. 6, in some embodiments, a user can select an amount of points to redeem to obtain a desired discount (e.g., user can dial in a precise number of points, or can be offered two or a few options). A different user may be offered a personalized discount or the same discount, but based on a personalized redemption rate that is different than the first user's redemption rate.

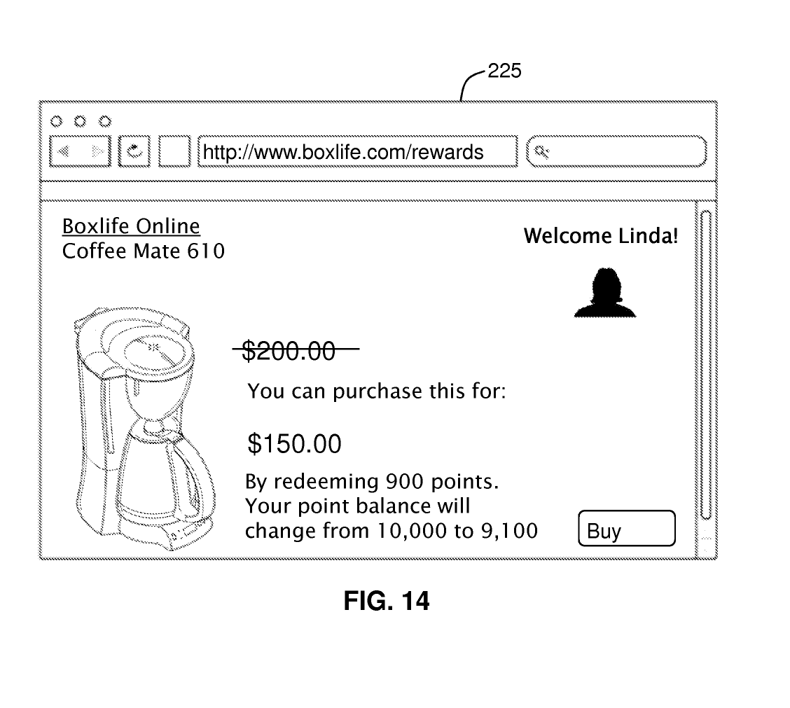

FIG. 14 shows receiving the discount at a different redemption rate by a different user. Here, a hypothetical user (e.g., “Linda”) sees that she may receive a $50 discount by redeeming 900 points—defining a personalized redemption rate for this user for this purchase.

By proffering personalized redemption rates, systems and methods of the invention allow consumers to access products at ultimately different costs, even where the facial dollar amount of the instant transaction is the same. It may be found that consumers would be alienated by apparently discriminatory pricing. Here, a redemption rate is determined based on variables such as a consumer's frequency of earning points, total points earned, other activities, or a combination thereof. Each transaction may be executed by different users for the same instant cost, but the applied incentive may cause the depletion of the corresponding user's rewards points by a personalized amount based on a personalized redemption rate.

In a preferred embodiment, the number of points required to achieve a specific discount level changes based on a unique algorithm that creates a point allocation from: a total points earned (more points means fewer are required for the discount level); a frequency of points earned (more frequent point earning transactions increase points weighting or fewer points required to achieve the discount); average social network activity over a period (e.g., past 30 days); how recent a last transaction was (more recent transaction gives a higher point weighting with a result that few points are required to get the discount); time of day (e.g., more points are awarded during non-peak periods); others; or a combination thereof. The invention provides methods for determining discounts or for granting pre-determined discounts and depleting points according to personalized redemption rates and for presenting discounts to consumers.

In some embodiments, systems and methods of the invention make use of a discriminant factor. A discriminant factor may be a stored value based on business rules, a calculation, decisions and input by an administrator, or received from an extrinsic source. A discriminant factor may be a status in a rewards program, for example.

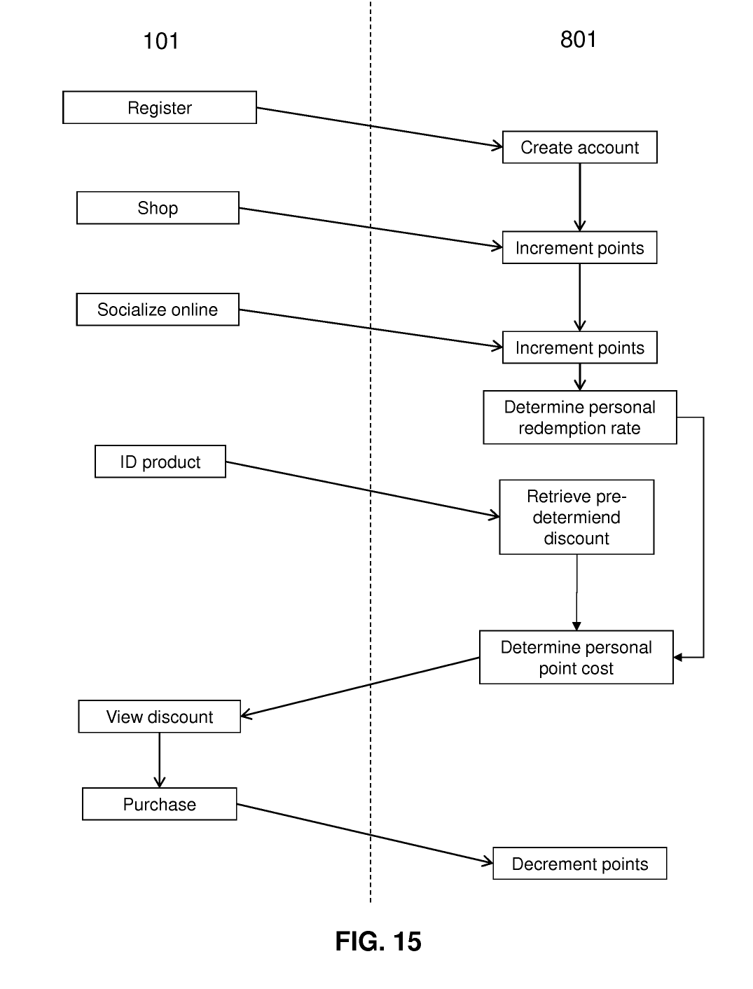

FIG. 15 diagrams methods of the invention. A consumer performs activities and transactions using a mobile device 101, a computer device 201, or both. Aspects and components of a rewards program may be performed through the use of a server computer 801. In general, a consumer will use a computer device to register for a program. A server is used to create an account for the user. As discussed above, a consumer earns points by shopping and social activity. Program instructions executed via the server computer cause a tally of the consumer's earned points to be incremented. Additionally, the server system may be used to determine a redemption rate.

To redeem points, a consumer may identify a product. A consumer may identify a product to the system by scanning the product (e.g., in store by QR code or barcode), by initiating the use of a store's POS system, or by shopping for the product online. For a given purchase, the system 801 can retrieve a pre-determined discount and use the consumer's redemption rate to determine a personal point cost for that purchase for that consumer. The consumer views the discount via device 101 and makes the purchase. Server system 801 can then deplete the consumer's account of points in the amount of the determined point cost.

An additional feature for companies that are trying to sell a particular item, is an ‘Instant Offer’. This is a discount provided beyond the standard three choices designed to motivate the user to make that purchase immediately. It may be time-based (in the next five minutes), provided as a ‘surprise’, and once the offer expires it is not available after the time limit.

In other embodiments, points can be made equal to a specific dollar amount. Points can also be allocated to missions specifically or to mission categories. A consumer can earn points via the missions and redeem the points up to a maximum discount on any item (e.g., half off, free, or rebate coming). For example, in some embodiments, a retailer defines the value of a mission by category: bringing someone shopping with you-50 points; uploading or broadcasting on a social media site such as one of those maintained under the trademarks TWITTER or FACEBOOK-5 point each; re-tweeting or commenting about a purchase on another person's social media “wall”—10 point; uploading a picture or video while shopping—15 points; purchasing a new items at full retail price—100 points for each $10 spent; others; or a combination of these. The consumer then can redeem as many of their points as they like up to a maximum and the price rolls back before their eyes as they enter how many points they want to redeem.

In certain embodiments, systems and methods of the invention include use of a POS Interface. Components of a rewards program can be administered using any product or POS system by simply either scanning a Bar Code or QR Code on the item or on the bill for the item (such as a restaurant receipt). A built in scanner module can be provided as part of an application that can capture price information (e.g., reflected on a restaurant bill) and calculate a discount based on the above criteria in real time. Use of a mobile app or application with mobile device 101 can provide an in-store rewards experience in some embodiments.

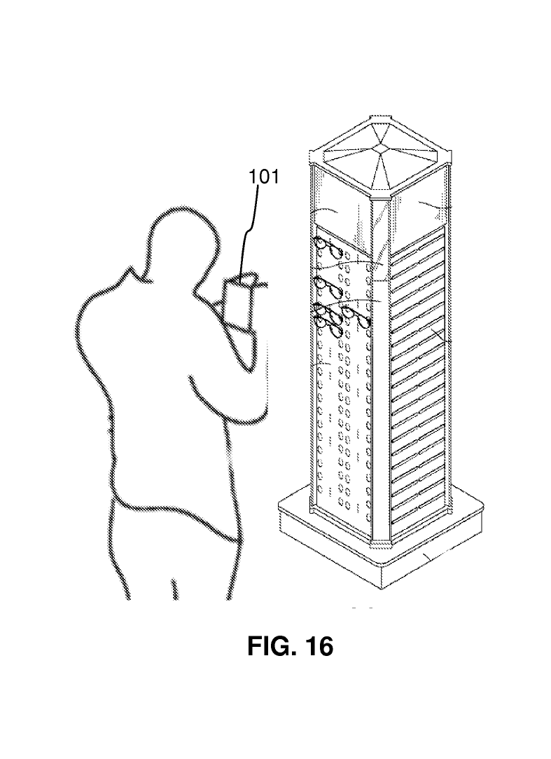

FIG. 16 illustrates identifying a product. Here, a consumer has identified a product in-store that they may wish to buy and is using mobile device 101 to interact with a rewards program.

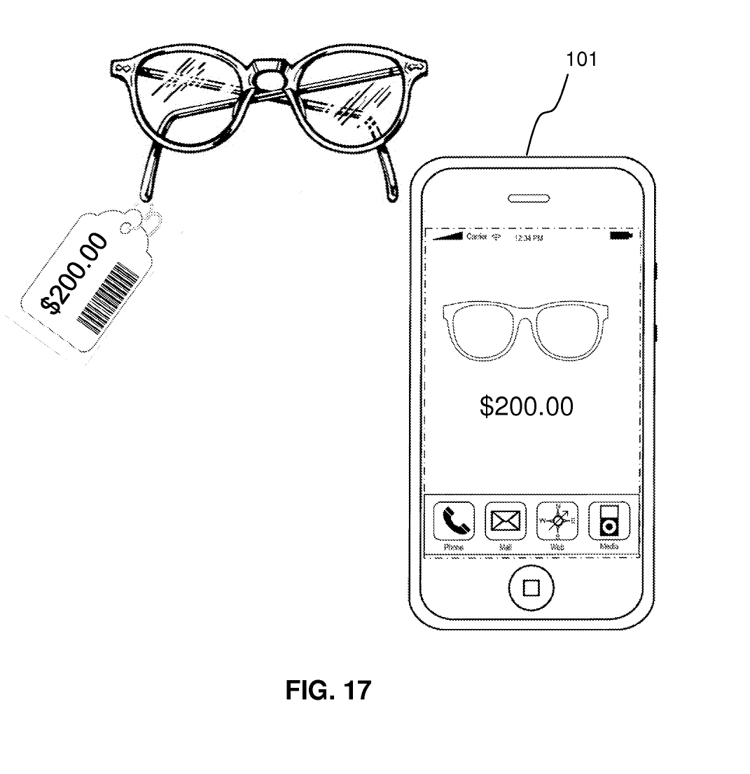

FIG. 17 shows an interaction with a rewards program via mobile device 101 in detail. Having identified a product of interest, a user can then identify the product using device 101. Identification can include looking up the product online, or scanning a QR code or barcode (pictured). Mobile device 101 can present a retail device for the product. By interacting with rewards program (e.g., through server 801), a consumer can be offered a discount on the product.

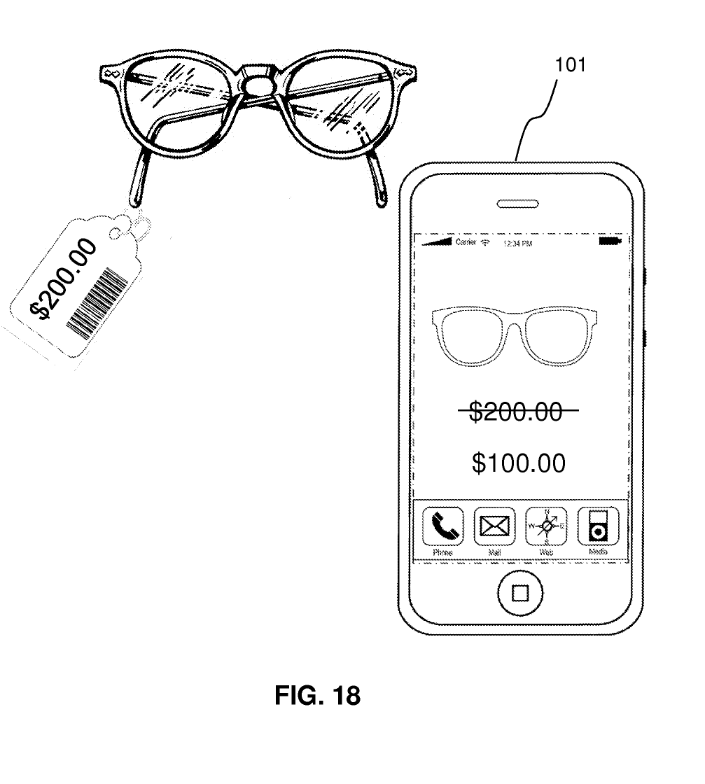

FIG. 18 shows viewing a discount via a device. Here, the consumer sees the price for the product roll back to a discounted price right before their eyes. This may reflect a real-time facet of the invention in some embodiments. For example, where the discount is pre-determined and simply looked up via software, and a user's redemption rate is calculated according to a formula, a display of the invention can present a discount in real time as a user inquires about a product incentive. The redemption rate will deplete the user's account by a personalized amount if the user makes a purchase.

A rewards program is preferably administered through the use of a system that includes a computer server system 801 and at least one user computer device 101.

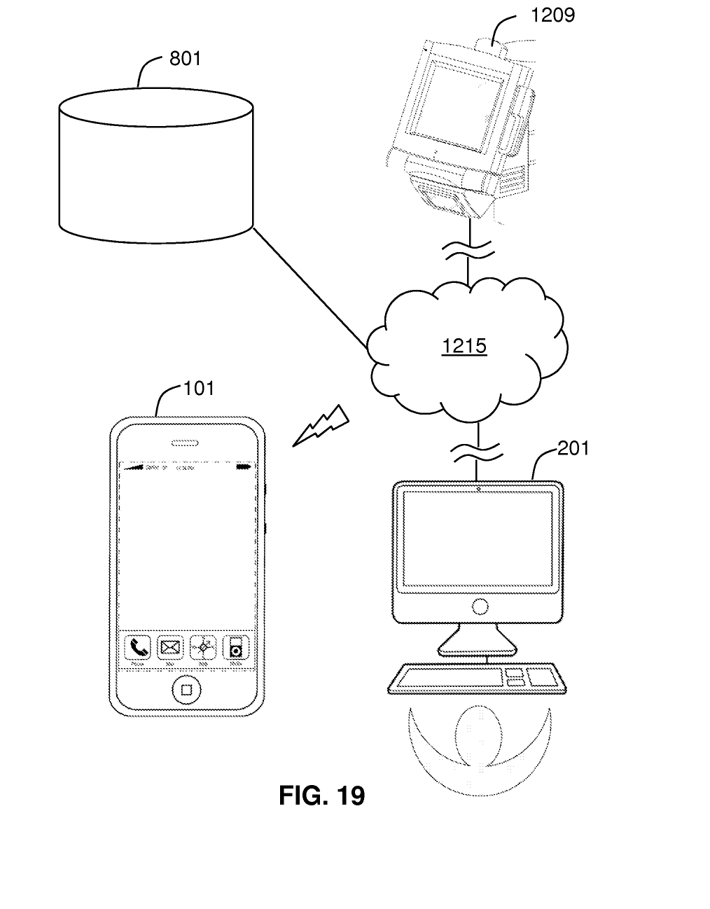

FIG. 19 depicts components of a system of the invention. Server 801 communicates with user computer device 201 or mobile device 101 via network 1215. A retailer's POS system 1209 can also be connected via network 1215. Use of server 801 allows features and components of a rewards system to be executed and maintained (e.g., even when no particular consumer is connected or using a computing device 101). A server 801 may include software suited for implementing methods described herein. One of skill in the art will appreciate that methods described herein can be implemented using any suitable programming language, development environment, or combination thereof. For example, Java, Ruby on Rails, Groovy and Grails, Perl, C++, or other development products may be employed to deploy the functionality, systems, and methods described herein. In some embodiments, server 801 includes executable instructions (e.g., program code in modules or objects). Additionally, server 801 an provide a business rules engine and a dashboard (e.g., as can be accessed via a user such as an administrator of a rewards program through the use of a computer device 201). A business rules engine can be used that increases or decreases the frequency of missions based on a set of algorithms that can include: a speed of completion (users that accept and complete missions quickly are sent new missions at a greater rate until their completion speed changes); a maximum threshold of each ‘type’ of mission (e.g., set at the beginning of the program to allow the program sponsor to predict and manage their discount liability); others; or a combination thereof.

In some embodiments, a type of mission completed will trigger a sequence of linked missions based on the completion of prerequisite missions. For example, if the first mission in the Harry Potter Quest is the completion of a mission to find Herminie Grainger's wand, the next mission involves using her wand to complete the second mission. This is triggered by uploading the Proof of Completion associated with finding the wand. In a retail setting, a customer sent a mission to upload a picture to Facebook that does not respond across a time period is not sent further Facebook related missions unless their profile changes with a Facebook login. However, if they are sent a mission to send a tweet, this can trigger more missions suggesting tweeting until their response to those missions changes.

A user's location may also trigger a specific type of mission based on the ‘earn’ and ‘redeem’ partners included in their profile. If the user indicates they are interested earning or redeeming rewards at Appleby's and they appear within 500 feet of an Appleby's restaurant, the business rules engine would trigger those specific missions. Secondly, a business rules engine may determine, based on the user's previous behaviors (they accepted 3 Appleby's missions and no Panera Bread missions), what missions they are likely to complete. These missions can also be triggered based on location and businesses where a user has “checked in” (via a program such as one of those sold under the trademark FACEBOOK or FOURSQUARE) or have “mentions” on Twitter.

Server 801 may additionally provide software for predictive analytics via a data analytics module that gathers the results of program participation or mission history by all of the users participating in the program and provide interested “Earn” and “Redeem” partners with insight into which program components or missions achieve the greatest response and what levels of discounts offered create the most significant behavior change, especially in both purchase behavior and social advocacy. Using predictive analytics, a company's designated administrator can conduct an analysis of price and volume performance on product categories for their competitive set and see where they rank across a set of criteria. Predictive analytics can analyze average social network activity over a period (e.g., past thirty days). The invention also provides a marketer with next logical product offers to customers and third parties based on mobile scanning history that did not lead to conversion.

In certain embodiments, an analytics module can use data mining to analyze consumers' social activities, purchase behaviors, browsing behaviors, other records, or a combination thereof. The analytics module can provides a marketer the ability to choose the social channels that specific customer segments are demonstrating—based on their actual behaviors—to be most relevant to improving the ROI for marketing investments. A predictive analytics module may, based on the response from a critical mass of customer segments to specific types of missions, provide a forecast as to what changes a retailer might expect to see in terms of changes in store traffic or purchases based on the launch of specific missions or program components that have proven to generate specific customer behaviors.

Server 801 may optionally include a transaction and settlement module. For example, where a rewards program is implemented under a multi-party model, customer participant firms that choose to provide financial rewards need to settle the pay back of the given financial rewards to the company's funding the discounts. For example, if Panasonic agreed to fund the rollback for the purchase of their Digital TV at a Best Buy Store, the invention settlement system settles involved accounts and creates payments withdrawals and deposits via escrow accounts at the end of a pre-defined time interval of participating companies.

Systems and methods of the invention such as the components and features described herein can be implemented through the use of devices configured to execute functionality described herein.

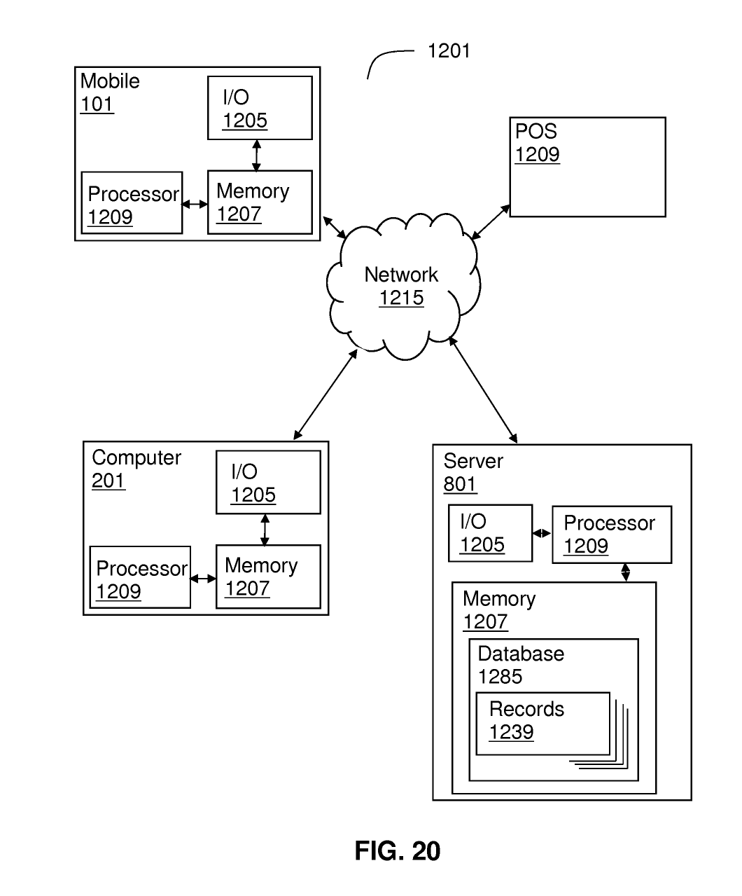

FIG. 20 diagrams components of a system 1201. Preferably, any of mobile device 101, computer device 201, or server 801 may include a processor 1209 coupled to a memory 1207 and an input/output (I/O) device 1205). A processor generally refers to a computer microchip such as the processor sold under the trademark CORE 17 by Intel (Santa Clara, Calif.). A memory 1207 generally includes one or more devices for random access, storage, or both. Preferably, memory 1207 includes a tangible, non-transitory computer readable medium, and may be provided by one or more of a solid state drive (SSD), a magnetic disc drive (aka, “a hard drive”), flash memory, an optical drive, others, or a combination thereof. I/O device 1205 may include one or more of a monitor, keyboard, mouse, touchscreen, Wi-Fi card, cell antenna, Ethernet port, USB port, light, accelerometer, speaker, microphone, drive for removable disc, others, or a combination thereof. Preferably, any combination of mobile device 101, computer device 201, server 801, and POS 1209 may communicate through the use of a network 1215, which may include communication devices for internet communication, telephonic communication, others, or a combination thereof. In certain embodiments, server system 801 will include a processor 1209 coupled to a tangible, non-transitory memory 1207 and contain instructions executable by processor 1209 to cause server system 801 to perform functions described herein.

Systems and methods of the invention allow a retailer to provide precise, personalized discounting not through price, but through what is required in points to redeem a fixed discount or a maximum. This protects the retailer's level of markdown while still incenting the desired consumer behaviors: frequent visits, high conversion, higher average ticket and higher traffic while minimizing the impact to gross margins.

Systems and methods of the invention include points allocation that can be calculated in real-time based on algorithms that influence the consumer while taking into account a value of the consumer and, by proxy, the consumer's profile, to a retailer or administrator of a rewards program. A value can be influenced by a consumer's demonstrated shopping and social behavior, a retailer's desire to sell the item, or both.

Systems and methods of the invention allow the flexibility to move unwanted inventory through “Instant Offers” that surprise and delight the consumer in an unpredictable way.

Systems and methods of the invention can be structured to include points redemption for things other than discounts such as, for example, favored treatment when new products are introduced, special hours, a designer ‘meet and greets’, an invitation to a trunk show, others, or a combination thereof. In certain embodiments, points are redeemed for incentives that cost the retailer little but would be of high value to the consumer.

Using systems and methods of the invention, a retailer is in a real-time dialogue with their customer and with that, their location, preferences, price tolerances for specific items and style preferences are tracked and predicted over time. One of skill in the art will recognize features that can be used to deploy a rewards program. For example, rewards programs are discussed in U.S. Pat. No. 8,285,588 to Postrel; U.S. Pat. No. 6,571,216 to Garg; U.S. Pub. 2013/0054327 to Ross; U.S. Pub. 2013/0073351 to Bair; U.S. Pub. 2012/0215608 to Paulos; U.S. Pub. 2012/0239465 to McInnes; and U.S. Pub. 2010/0274655 to Postrel, and the contents of each of those are incorporated by reference in their entirety for all purposes.

As used herein, the word “or” means “and or or”, sometimes seen or referred to as “and/or”, unless indicated otherwise.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A method of influencing consumer behavior comprising using a computer system for:
giving a consumer reward points for performing activities that include promotional activity and the purchasing of a product;
receiving a transaction request from a payment institution;
debiting a merchant account by a discount amount;
crediting the payment institution; and
depleting the consumer's reward points by an amount.

2. The method of claim 1, further comprising depleting reward points for different people at different redemption rates.

3. The method of claim 2, wherein the promotional activity comprises use of a networking website to make public mention of a product.

4. The method of claim 1, further comprising:
providing the consumer with a computer executable application that a consumer can execute on a mobile computing device to cause the mobile device to scan a product code; and
displaying on the mobile device a discounted price for product.

5. The method of claim 4, wherein displaying the discounted price comprises:
displaying an original price number;
displaying a transition; and
displaying a final discounted price number.

6. The method of claim 5, wherein the transition is an animation comprising numbers between the original price number and the final discounted price number.

7. The method of claim 1, further wherein the method comprises giving consumers reward points for performing activities that include performing assigned missions.

8. The method of claim 1, wherein the payment institution comprises a credit card issuer.

9. An apparatus for facilitating a purchase, the apparatus comprising:
a mobile device form-factor body comprising a processor coupled to a non-transitory memory, the apparatus comprising a computer program operable to cause the apparatus to:
obtain an identity of a product;
receive information about a discount from a credit card payment institution;
display an undiscounted price for the product and a discounted price for the product; and
show a user an amount of rewards points that will be depleted to obtain the discount.

10. The apparatus of claim 9, further operable to scan a surface to obtain the identity of the product.

11. A method for influencing consumer behavior comprising using a computer device comprising a memory coupled to a processor to:
give consumers reward points for performing activities that include online product promotion and the purchasing of a product;
process a transaction request from a credit card issuer;
offer the consumers discounts on a purchase; and
for each consumer that accepts the offer, deplete that consumer's reward points by an amount, debit a merchant account by an amount of the discount, and pay the issuer.

12. The method of claim 11, further comprising depleting each consumer's reward points at a personalized redemption rate.

13. The method of claim 11, further comprising:
providing each consumer with a mobile app for use on a mobile device; and
displaying on the mobile device a discounted price for product.

14. The method of claim 13, wherein displaying the discounted price comprises:
displaying an original price number;
displaying a transition; and
displaying a final discounted price number.

15. A system for providing products, the system comprising a computer system operable to:
tally an amount of points earned by each of a plurality of people through a combination of promotional and shopping activity in a computer system;
offer a discount to each of the plurality of people at a personalized point rate;
debit a merchant at least a first portion of the discount; and
credit a credit card issuer at least a second portion of the discount.

16. The system of claim 15, wherein offering the discount comprises causing a mobile device to display the discounted price.

17. The system of claim 15, further wherein the computer system is operable to cause a computer device to display an animation showing the retail price change to the discounted price.

18. The system of claim 15, further wherein the computer system is operable to assign missions to each of the plurality of people, and further wherein the points are earned by performing the assigned missions.

19. The system of claim 18, wherein the missions include promoting a product to users of a web site.

20. The system of claim 15, wherein the issuer funds the discount by accepting the credit and invoicing each of the plurality of people by the discounted amount.
